(19) United States
(12) Patent Application Publication
(10) Pub. No.: US 2024/0292398 A1
(43) Pub. Date: Aug. 29, 2024

(54) INITIAL ACCESS METHOD, BASE STATION, AND USER EQUIPMENT

(71) Applicant: Huizhou TCL Cloud Internet Corporation Technology Co., Ltd., Huizhou, Guangdong (CN)

(72) Inventors: Aijuan FENG, Huizhou, Guangdong (CN); Jia SHENG, Huizhou, Guangdong (CN)

(73) Assignee: Huizhou TCL Cloud Internet Corporation Technology Co., Ltd., Huizhou, Guangdong (CN)

(21) Appl. No.: 18/568,887

(22) PCT Filed: Jul. 9, 2021
(86) PCT No.: PCT/CN2021/105612

§ 371 Date: Dec. 11, 2023

(51) Int. Cl. H04W 72/0457; H04W 72/1273; H04W 72/51; H04W 74/0833; H04W 76/20

(52) U.S. Cl. CPC H04W 72/0457; H04W 72/1273; H04W 72/51; H04W 74/0833; H04W 76/20

(57) ABSTRACT

An initial access method for an extended type of user equipment (UE) is executable in a base station (BS). The BS broadcasts configuration of a common control-resource set (CORESET) for the extended UE type, such as reduced capability (RedCap) UE. The BS broadcasts configuration of an initial bandwidth part (BWP) for the extended UE type in the common control-resource set. The initial BWP for the extended UE type is an initial BWP shared by the extended UE type and a legacy UE type or a separated initial BWP dedicated to the extended UE type in addition to an initial BWP for a legacy UE type. The common CORESET for the extended UE type comprises an entirety, a part, or an extension of a common CORESET for the legacy UE type or a separated common CORESET for the extended UE type.

### TECHNICAL FIELD

The present disclosure relates to the field of communication systems, and more particularly, to an initial access method, a base station, and a user equipment (UE).

### BACKGROUND ART

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN comprises a set of base stations (BSs) that provide wireless links to the UEs located in cells covered by the base station, and an interface to a core network (CN) which provides overall network control. As will be appreciated the RAN and CN each conduct respective functions in relation to the overall network. The 3rd Generation Partnership Project has developed the so-called Long Term Evolution (LTE) system, namely, an Evolved Universal Mobile Telecommunication System Territorial Radio Access Network, (E-UTRAN), for a mobile access network where one or more macro-cells are supported by a base station known as an eNodeB or eNB (evolved NodeB). More recently, LTE is evolving further towards the so-called 5G or NR (new radio) systems where one or more cells are supported by a base station known as a gNB.

### Technical Problem

In 3GPP standard release 17, a work item (WI) “Support of reduced capability NR devices” has been started to develop. The objectives of standard development regarding reduced capability UEs (RedCap UEs) include features supporting the UE complexity reduction, for example, reducing maximum UE bandwidth and a minimum number of branches of signal receiving circuits (Rx).

### Technical Solution

An object of the present disclosure is to propose an initial access method, a base station, and a user equipment (UE).

In a first aspect, an embodiment of the invention provides an initial access method for an extended user equipment (UE) type, executable in a base station (BS), comprising:
broadcasting configuration of a common control-resource set (CORESET) for the extended UE type; and
broadcasting configuration of an initial downlink bandwidth part (BWP) for the extended UE type in the common control-resource set.

In a second aspect, an embodiment of the invention provides a base station comprising a transceiver and a processor. The processor is connected to the transceiver and configured to execute the following steps:
broadcasting configuration of a common control-resource set (CORESET) for the extended UE type; and
broadcasting configuration of an initial downlink bandwidth part (BWP) for the extended UE type in the common control-resource set.

In a third aspect, an embodiment of the invention provides an initial access method for an extended user equipment (UE) type, executable in a user equipment (UE), comprising:
receiving broadcast configuration of a common control-resource set (CORESET) for the extended UE type; and
receiving broadcast configuration of an initial downlink bandwidth part (BWP) for the extended UE type in the common control-resource set.

In a fourth aspect, an embodiment of the invention provides a user equipment comprising a transceiver and a processor. The processor is connected to the transceiver and configured to execute the following steps:
receiving broadcast configuration of a common control-resource set (CORESET) for the extended UE type; and
receiving broadcast configuration of an initial downlink bandwidth part (BWP) for the extended UE type in the common control-resource set.

The disclosed method may be implemented in a chip. The chip may include a processor, configured to call and run a computer program stored in a memory, to cause a device in which the chip is installed to execute the disclosed method.

The disclosed method may be programmed as computer executable instructions stored in non-transitory computer readable medium. The non-transitory computer readable medium, when loaded to a computer, directs a processor of the computer to execute the disclosed method.

The non-transitory computer readable medium may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

The disclosed method may be programmed as a computer program product, that causes a computer to execute the disclosed method.

The disclosed method may be programmed as a computer program, that causes a computer to execute the disclosed method.

### Advantageous Effects

An embodiment of the invention provides an initial access method to address the problems of heavy traffic offloading of initial DL BWP. An embodiment of the invention provides an initial access method to address the problems of the same center frequency issue of initial DL/UP BWP in TDD case.

### DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 illustrates a schematic view of an initial downlink (DL) bandwidth part (BWP) and a common CORESET (CORESET #0).

FIG. 2 illustrates a schematic view showing a legacy random access (RA) procedure.

FIG. 3 illustrates a schematic view of a telecommunication system.

FIG. 4 illustrates a schematic view showing an embodiment of the disclosed initial access method.

FIG. 5 illustrates a schematic view showing an embodiment of enabling or disabling an enhanced CORESET #0 for an extended UE type.

FIG. 6 illustrates a schematic view showing an embodiment of selecting a CORESET #0 for message transmission to one or more UE of an extended UE type.

FIG. 7 illustrates a schematic view showing an embodiment of message transmission to one or more UEs of the extended UE type.

FIG. 8 illustrates a schematic view showing an embodiment of selecting a CORESET #0 for on-demand and non-on-demand system information block (SIB) transmission to one or more UE of the extended UE type.

FIG. 9 illustrates a schematic view showing a separate CORESET #0 for RedCap UEs and relation between a new CORESET #0 and a legacy CORESET #0.

FIG. 10 illustrates a schematic view showing a mapping between a new CORESET #0 and a legacy CORESET #0.

FIG. 11 illustrates a schematic view showing a base station configuring a new CORESET #0 in a mater information block (MIB).

FIG. 12 illustrates a schematic view showing an embodiment of on-demand system information block (SIB) transmission to one or more UE of the extended UE type.

FIG. 13 illustrates a schematic view showing an embodiment of transmission of random access DL messages to one or more UE of the extended UE type.

FIG. 14 illustrates a schematic view showing an embodiment of configuring the new CORESET #0 in SIB1 and SIBx.

FIG. 15 illustrates a schematic view showing an embodiment of a random access (RA) procedure using the new CORESET #0.

FIG. 16 illustrates a schematic view showing embodiments of an extension of a legacy CORESET for the extended UE type.

FIG. 17 illustrates a schematic view showing a mapping between a CORESET #0 extension for the extended UE type and a legacy CORESET #0.

FIG. 18 illustrates a schematic view showing embodiments of a part of a legacy CORESET for the extended UE type and a mapping between the part of the CORESET #0 for the extended UE type and the legacy CORESET #0.

FIG. 19 illustrates a schematic view showing embodiments of configuring new CORESET #0 and new initial DL BWP for the extended UE type.

FIG. 20 illustrates a schematic view showing more embodiments of configuring new CORESET #0 and new initial DL BWP for the extended UE type.

FIG. 21 illustrates a schematic view showing an example of sharing one CORESET #0 by a new initial DL BWP and a legacy initial DL BWP.

FIG. 22 illustrates a schematic view showing more embodiments of configuring new initial DL BWP for the extended UE type and an SIB transmission procedure.

FIG. 23 illustrates a schematic view showing an embodiment of a random access (RA) procedure using the new initial DL BWP.

FIG. 24 illustrates a schematic view showing an example of one CORESET #0 shared by a separate initial DL BWP for RedCap UEs and a legacy initial DL BWP for non-RedCap UEs.

FIG. 25 illustrates a schematic view showing an example of different common CORESETs (CORESET #0) with different initial DL BWPs.

FIG. 26 illustrates a schematic view showing an embodiment of a random access (RA) procedure using the new initial DL BWP or new CORESET #0.

FIG. 27 illustrates a schematic view showing embodiments of an extension of a legacy CORESET for the extended UE type.

FIG. 28 illustrates a schematic view showing a system for wireless communication according to an embodiment of the present disclosure.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The reduced capability UEs (RedCap UEs) may include:
Industrial wireless sensors: such as pressure sensors, humidity sensors, thermometers, motion sensors, accelerometers, actuators, etc.
Surveillance cameras: such as surveillance cameras in smart city use case which covers data collection and processing to more efficiently monitor and control city resources, and to provide services to city residents.
Wearable devices: such as smart watches, rings, eH-ealth related devices, and medical monitoring devices, etc.

Whether to configure a separate initial downlink (DL) bandwidth part (BWP) and/or a separate/additional common control-resource set (CORESET #0) for RedCap UES are ongoing issues. Currently, an agreement has been achieved that RedCap UEs and non-RedCap UEs (e.g., legacy UEs) can coexist in the same cell.

Shared initial DL BWP between RedCap and non-RedCap UEs may have a congestion issue when a large number of RedCap UEs are in a cell. Non-RedCap UES may be affected. A separate initial DL BWP may be used to offload the traffic.

Due to certain scenarios, eight frequency division multiplexed (FDMed) random access occasions (ROs) or uplink (UL) frequency hopping exceeds the maximum bandwidth of UE. The uplink frequency hopping may comprise physical uplink control channel (PUCCH) and/or physical uplink shared channel (PUSCH) frequency hopping. Thus, configuring a separate initial UL BWP for RedCap UE is required.

Considering that in a time division duplexing (TDD) scenario, a DL and an UL need to have the same center frequency, a separate initial DL BWP for the RedCap UE may be configured to associate with a separate initial UL BWP for the RedCap UE.

In the current mechanism, a common control-resource set (CORESET #0) is actually used as the initial DL BWP before and during the random access processing (as shown in Table 1). The initial DL BWP configured in system information block one (SIB1) only takes effect after random access. So, the aforementioned issues of initial DL BWP are also issues of CORESET #.

TABLE 1

| Stage | DL BWP | UL BWP | Processing |
|---|---|---|---|
| PSS and SSS Decode | | | DL synchronization |
| MIB decode | | | UE decode MIB and get |
| | | | CORESET#0 configuration |
| SIB 1 decode | CORESET#0 | | Get Initial DL/UL BWP settings from |
| | | | SIB1 decoding, if the configurations exist. |
| msg 1 (UE −> gNB) | | Initial | Random access request to gNB |
| | | UL BWP | |
| msg 2 (gNB −> UE) | CORESET#0 | | RAR from gNB |
| msg 3 (UE −> gNB) | | Initial | RRC connection request |
| | | UL BWP | |
| msg 4 (gNB −> UE) | CORESET#0 | | RRC connection setup. |
| | | | Configure UE-dedicated |
| | | | BWP(default BWP/1st active BWP/other |
| | | | BWP). |
| | | | If not configured, still use initial |
| | | | BWP. |
| msg 5 (UE −> gNB) | 1st | | |
| | Active BWP | | |

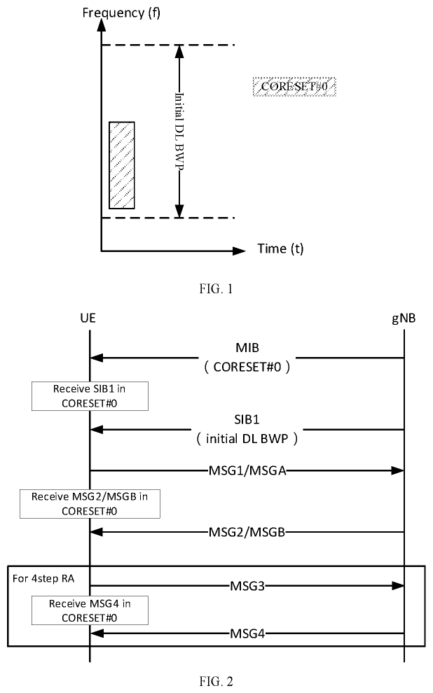

With reference to FIG. 1, in a serving cell, an initial DL BWP is associated with a CORESET #0, and the initial DL BWP generally contains the entire CORESET #0 of this serving cell in the frequency domain. During the random access phase, CORESET #0 is actually used as the initial DL BWP. The initial DL BWP configured in SIB1 takes effect after random access.

With reference to FIG. 2, the master information block (MIB) provides CORESET #0 and common search space (CSS #0) configuration for monitoring PDCCH that carrying SIB1. The parameter “controlResourceSetZero” indicates an index which determines a common CORESET #0, as described in 3GPP technical specification (TS) 38.213 that provides tables for operation without shared spectrum channel access, and tables for operation with shared spectrum channel access. CORESET #0 is detailed in TS 38.213. The parameter “searchSpaceZero” indicates an index which determines PDCCH monitoring occasions from searchSpaceZero, as described in TS 38.213.

A gNB provides the initial DL BWP configuration in SIB1. DL messages mentioned in the disclosure may comprise one or more of synchronization signal block (SSB), paging, remaining minimum system information (RMSI) (e.g., SIB1), other system information (OSI) (e.g., SIBx), and physical random access channel (PRACH) DL messages (e.g., msg2, msg4, and msgB) during random access. Embodiments of the invention addresses on which resources (e.g., legacy CORESET #0, new CORESET #0, new initial DL BWP) these DL messages are transmitted or received. The initial DL BWP of course can be used for other messages. Sharing the legacy initial DL BWP between RedCap UEs and non-RedCap UEs.

In frequency-division duplexing (FDD), the center frequency of initial UL BWP and initial DL BWP are not required to be the same, so even if a separate initial UL BWP is configured for RedCap UEs, a legacy initial DL BWP can be used to RedCap UEs without requiring a separate DL BWP.

Assumed that the requirement for center frequency consistency is removed in TDD case, so even if a separate initial UL BWP is configured for RedCap UEs, a separate initial DL BWP is not necessary and only the legacy initial UL BWP can be allocated for RedCap UEs.

An embodiment of the disclosed initial access method can be achieved by enhancing the CORESET #0 mechanism to offload traffic. For example, a separate CORESET #0 (referred to as new CORESET #0 hereafter) may be allocated to RedCap UEs. The separate CORESET #0 includes additional radio resources dedicated for RedCap UEs other than radio resources of legacy CORESET #0 for a legacy type of UE. Alternatively, RedCap UEs may be allocated a part of legacy CORESET #0 or entire legacy CORESET #0. Further, an extension of legacy CORESET #0 (or CORESET #0 extension) may be allocated to RedCap UEs.

The above-mentioned separate CORESET #0, an extension of legacy CORESET #0, and part of legacy CORESET #0 that are specific to RedCap UEs are collectively referred to as enhanced common CORESET or enhanced CORESET #0. Usage of the enhanced CORESET #0 are the same as the legacy CORESET #0. The enhanced CORESET #0 is actually used as an initial DL BWP for RedCap UEs before and during the random access processing (as shown in Table 1).

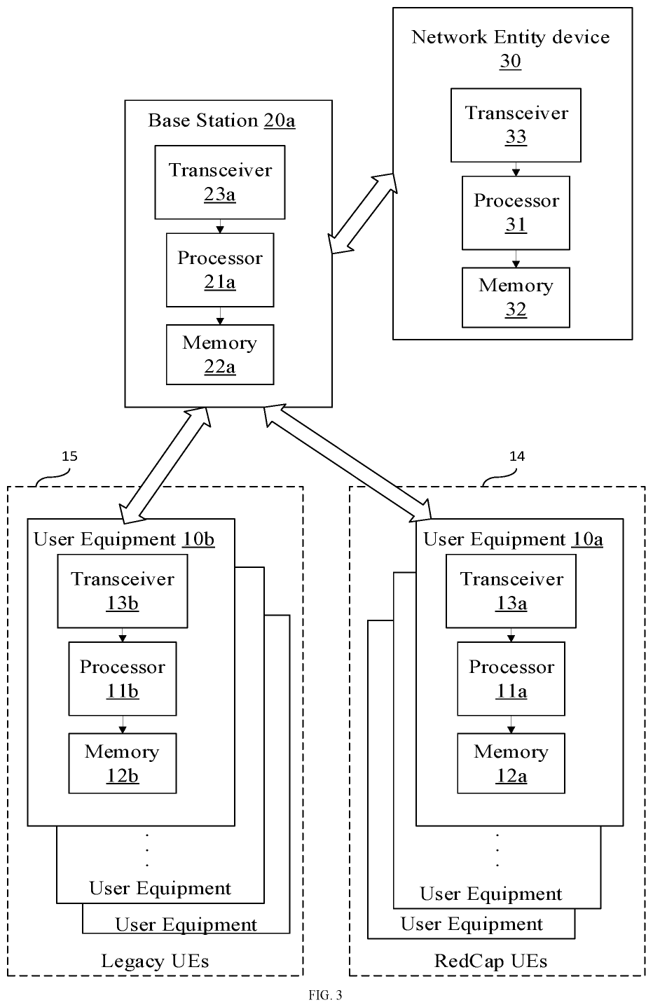

With reference to FIG. 3, a telecommunication system including a UE 10a, a UE 10b, a base station (BS) 20a, and a network entity device 30 executes the disclosed method according to an embodiment of the present disclosure. FIG. 3 is shown for illustrative not limiting, and the system may comprise more UEs, BSs, and CN entities. Connections between devices and device components are shown as lines and arrows in the FIGs. The UE 10a may include a processor 11a, a memory 12a, and a transceiver 13a. The UE 10b may include a processor 11b, a memory 12b, and a transceiver 13b. The base station 20a may include a processor 21a, a memory 22a, and a transceiver 23a. The network entity device 30 may include a processor 31, a memory 32, and a transceiver 33. Each of the processors 11a, 11b, 21a, and 31 may be configured to implement proposed functions, procedures and/or methods described in the description. Layers of radio interface protocol may be implemented in the processors 11a, 11b, 21a, and 31. Each of the memory 12a, 12b, 22a, and 32 operatively stores a variety of programs and information to operate a connected processor. Each of the transceivers 13a, 13b, 23a, and 33 is operatively coupled with a connected processor, transmits and/or receives radio signals or wireline signals. The base station 20a may be an eNB, a gNB, or one of other types of radio nodes, and may configure radio resources for the UE 10a and UE 10b. The telecommunication system comprises a plurality of UEs belong to an extended UE type in group 14 and a plurality of UEs belong to a legacy UE type in group 15. UEs belong to the extended UE type in group 14 comprise UE 10a, and UEs belong to the legacy UE type in group 15 comprise UE 10b.

Each of the processors 11a, 11b, 21a, and 31 may include an application-specific integrated circuit (ASICs), other chipsets, logic circuits and/or data processing devices. Each of the memory 12a, 12b, 22a, and 32 may include read-only memory (ROM), a random access memory (RAM), a flash memory, a memory card, a storage medium and/or other storage devices. Each of the transceivers 13a, 13b, 23a, and 33 may include baseband circuitry and radio frequency (RF) circuitry to process radio frequency signals. When the embodiments are implemented in software, the techniques described herein can be implemented with modules, procedures, functions, entities, and so on, that perform the functions described herein. The modules can be stored in a memory and executed by the processors. The memory can be implemented within a processor or external to the processor, in which those can be communicatively coupled to the processor via various means are known in the art.

The communication between UEs may be realized according to device to device (D2D) communication or vehicle-to-everything (V2X) communication. V2X communication includes vehicle-to-vehicle (V2V), vehicle-to-pedestrian (V2P), and vehicle-to-infrastructure/network (V2I/N) according to a sidelink technology developed under 3rd generation partnership project (3GPP) release 14, 15, 16, and beyond. UEs communicate with each other directly via a sidelink interface such as a PC5 interface.

The network entity device 30 may be a node in a CN. CN may include LTE CN or 5G core (5GC) which includes user plane function (UPF), session management function (SMF), mobility management function (AMF), unified data management (UDM), policy control function (PCF), control plane (CP)/user plane (UP) separation (CUPS), authentication server (AUSF), network slice selection function (NSSF), and the network exposure function (NEF).

With reference to FIG. 4, an initial access method for extended user equipment (UE) type is executable in a base station (BS), such as a gNB 20. An example of the extended UE type may comprise a type of reduced capability (RedCap) UE. An example of the gNB 20 may comprise the BS 20a. Note that even though the gNB is described as an example of base station in the following, the initial access method of the disclose may be implemented in any other types of base stations, such as an eNB or a base station for beyond 5G. Examples of UEs of the extended UE type may comprise RedCap UEs, such as UE 10a.

The gNB broadcasts configuration of a common control-resource set (CORESET #0) for the extended UE type to UEs (block 101). A UE 10 receives broadcast configuration of a common control-resource set (CORESET) for the extended UE type (block 102). An example of the UE 10 may comprise the UE 10a. The UEs receiving the CORESET #1 may include legacy UEs and UEs of the extended UE type.

The gNB broadcasts configuration of an initial bandwidth part (BWP) for the extended UE type in the common control-resource set (block 103). The UE 10 receives broadcast configuration of an initial BWP for the extended UE type in the common control-resource set (block 104). The initial BWP may comprise at least initial DL BWP or both of an initial DL BWP and an initial UL BWP. The initial bandwidth part for the extended UE type may be an initial downlink bandwidth part shared by the extended UE type and a legacy UE type. Alternatively, the initial bandwidth part for the extended UE type may be a separated initial downlink bandwidth part dedicated to the extended UE type in addition to an initial downlink bandwidth part for a legacy UE type. The configuration of the common CORESET for the extended UE type may be carried in a master information block (MIB). The common CORESET for the extended UE type may be an entirety of a common CORESET shared by the extended UE type and the legacy UE type. Alternatively, the common CORESET for the extended UE type may be an enhanced common CORESET for the extended UE type. The enhanced common CORESET for the extended UE type may be a part of a common CORESET for the legacy UE type. Alternatively, the enhanced common CORESET for the extended UE type may be a separated common CORESET dedicated to the extended UE type in addition to a common CORESET for the legacy UE type. Further, the enhanced common CORESET for the extended UE type may be an extension of a common CORESET for the legacy UE type.

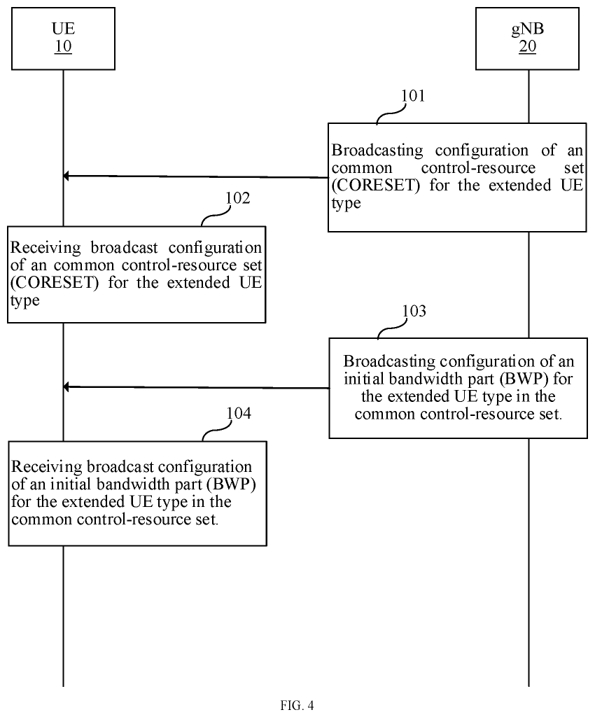

With reference to FIG. 5, the gNB 20 may determine whether to enable or disable the enhanced common CORESET and transmit an indication for enabling or disabling the enhanced common CORESET (block 210). The indication for enabling or disabling the enhanced common CORESET may be transmitted in MIB, a SIB with index one (i.e., SIB1), another SIB with a different index (referred to as SIBx), or a radio resource control (RRC) message.

The gNB 20 determines a common CORESET for transmission of one or more downlink messages for the extended UE type and transmits one or more downlink messages for the extended UE type based on the determined common CORES ET (block 212).

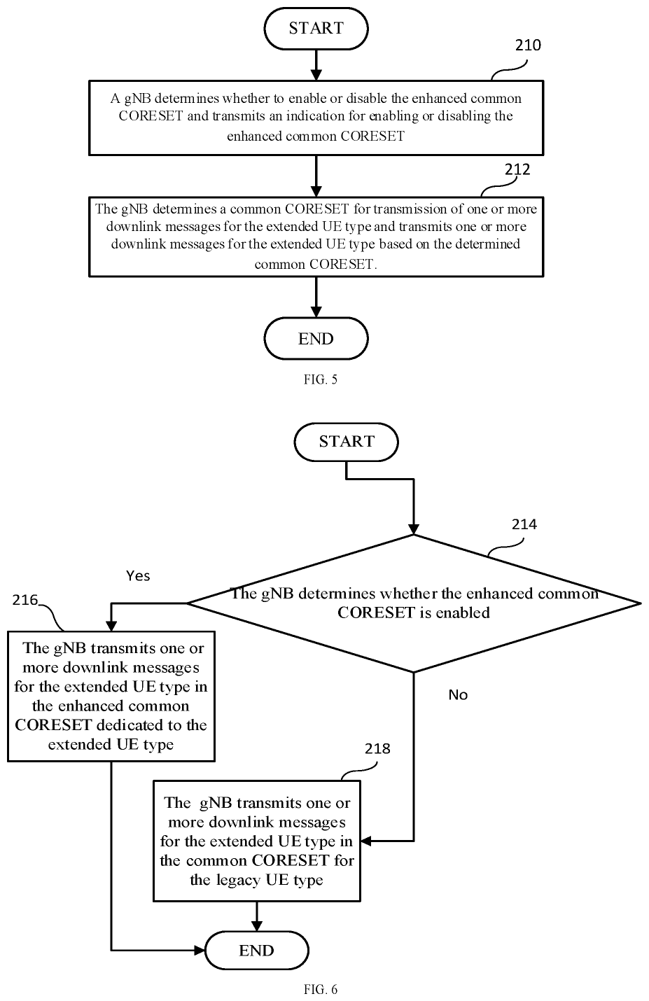

With reference to FIG. 6, the block 212 may further comprise blocks 214, 216 and 218. The gNB 20 determines whether the enhanced common CORESET is enabled (block 214). When the enhanced common CORESET is enabled, the gNB 20 transmits one or more downlink messages for the extended UE type in the enhanced common CORESET dedicated to the extended UE type (block 216). When the enhanced common CORESET is disabled, i.e., the enhanced common CORESET is not enabled, the gNB 20 transmits one or more downlink messages for the extended UE type in the common CORESET for the legacy UE type (block 218). At least one downlink message for the extended UE type is transmitted in the common CORESET for the legacy UE type when the enhanced common CORESET is initially not enabled, and at least one downlink message for the extended UE type is transmitted in the enhanced common CORESET dedicated to the extended UE type when the enhanced common CORESET subsequently enabled.

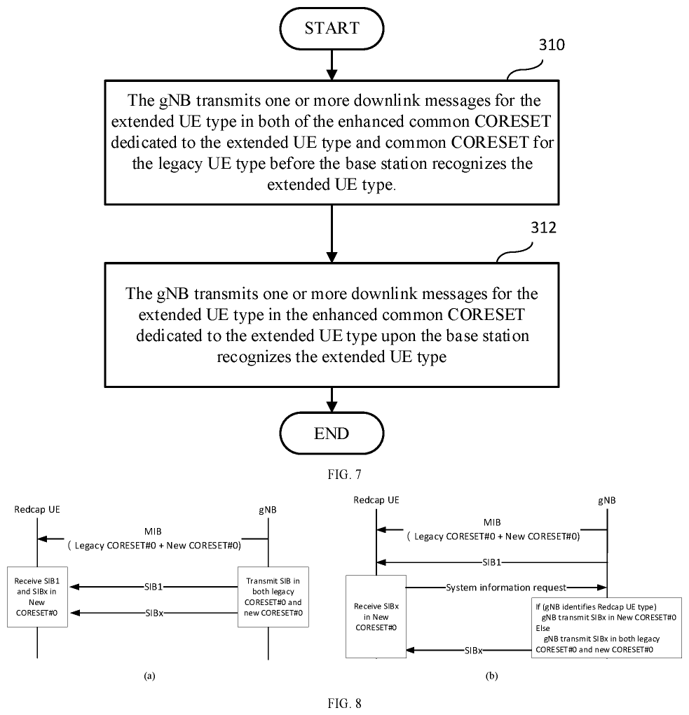

With reference to FIG. 7, the gNB 20 transmits one or more downlink messages for the extended UE type in both of the enhanced common CORESET dedicated to the extended UE type and common CORESET for the legacy UE type before the base station recognizes the extended UE type (block 310).

The gNB 20 transmits one or more downlink messages for the extended UE type in the enhanced common CORESET dedicated to the extended UE type upon the base station recognizes the extended UE type (block 312). The one or more downlink messages for the extended UE type comprise one or more of SIB, on-demand SIB, msg2, msg4, msgB, a synchronization signal block (SSB), and paging. The base station may recognize the extended UE type based on at least one of a separate initial uplink BWP, a separate random access channel (RACH) preamble, or a separate RACH occasion of the extended UE type.

With reference to FIG. 8, embodiments of the disclosed method for the cases (a) and (b) of non-sharing legacy CORESET #0 are provided, the enhanced common CORESET for the extended UE type is a separated common CORESET dedicated to the extended UE type in addition to a common CORESET for the legacy UE type. Before the gNB 20 recognizes RedCap UE type, the gNB 20 transmitted relevant DL messages, such as SIB1, SIBx, msg2/4/B, or paging in both legacy CORESET #0 and enhanced CORESET #0 while the RedCap UEs receive the DL messages in Enhanced CORESET #0. Once the gNB 20 recognizes RedCap UE type, the gNB 20 transmits relevant DL messages in the enhanced CORESET #0, and RedCap UEs receives the relevant DL messages in enhanced CORESET #0.

FIG. 8 shows examples of selecting a CORESET #0 according to which the gNB 20 transmits messages and RedCap UEs receive messages when a new CORESET #0 is configured in MIB.

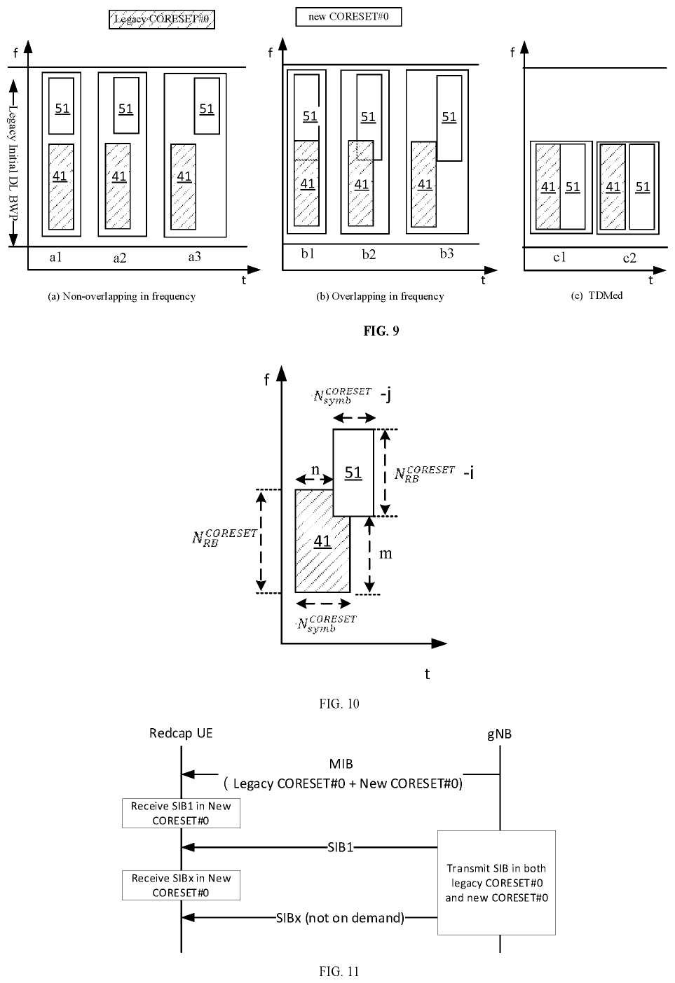

FIG. 9 shows a separate CORESET #0 for RedCap UEs and relation between a new CORESET #0 and a legacy CORESET #0.

Even though RedCap UEs and non-RedCap UEs can share the same legacy initial DL BWP, the gNB 20 may configure a separate CORESET #0 for redcap UEs, referred to as new CORESET #0 hereafter, such as a separate CORESET #0 51. The new CORESET #0 can be frequency division multiplexed (FDMed) or overlapped or time division multiplexed (TDMed) with the legacy CORESET #0 (e.g., CORESET #0 51 in FIG. 9), and the entire new CORESET #0 are contained in the legacy initial DL BWP.

### Time-Frequency Relationship Between New and Legacy CORESET #0:

When the common CORESET for the extended UE type is a separated common CORESET dedicated to the extended UE type in addition to the common CORESET for the legacy UE type, the separated common CORESET dedicated to the extended UE type may be multiplexed by the gNB 20 with the common CORESET for the legacy UE type without overlapping in a frequency domain. Alternatively, the separated common CORESET dedicated to the extended UE type may be multiplexed by the gNB 20 with the common CORESET for the legacy UE type with overlapping in a frequency domain.

The separated common CORESET dedicated to the extended UE type may be allocated the same radio resources with the common CORESET for the legacy UE type in a time domain. Alternatively, the separated common CORESET dedicated to the extended UE type may be multiplexed with the common CORESET for the legacy UE type without overlapping in a time domain. Further, the separated common CORESET dedicated to the extended UE type may be multiplexed with the common CORESET for the legacy UE type with overlapping in a time domain.

When the new CORESET #0 is non-overlapped in frequency domain with the legacy CORESET #0 (as shown in FIG. 9 a1-a3):
The new CORESET #0 is the same with the legacy CORESET #0 in time domain (as shown in FIG. 9 a1);
The new CORESET #0 overlaps with the legacy CORESET #0 in time domain (as shown in FIG. 9 a2); or
The new CORESET #0 does not overlap with the legacy CORESET #0 in time domain (as shown in FIG. 9 a2).

When the new CORESET #0 overlaps with the legacy CORESET #0 in the frequency domain (as shown in FIG. 9 b1-b3):
The new CORESET #0 is allocated the same resource in time domain (as shown in FIG. 9 b1);
The new CORESET #0 overlaps with the legacy CORESET #0 in time domain (as shown in FIG. 9 b2); or
The new CORESET #0 does not overlap with the legacy CORESET #0 in time domain (as shown in FIG. 9 b3).

The new CORESET #0 is TDMed with the legacy CORESET #0 (as shown in FIG. 9 c1 and c2).

### The Configuration of New CORESET #0:

### The Mapping Relationship Between New CORESET #0 and Legacy CORESET #0:

CORESET #0 configuration may contain the SSB-CORESET multiplexing mode, the number of CORESET #0 RBs, the number of CORESET #0 symbols, and the offset between CORESET #0 and the SSB's lowest RB index. Examples of configuration of common CORESET (CORESET #0 configuration) may be found in Tables in TS 38.213 chapter 13.

Configuration of the common CORESET for the extended UE type comprises a size (N_{symb}^{CORESET}−j) of the common CORESET for the extended UE type in a time domain and a size (N_{RB}^{CORESET}−i) of the common CORESET for the extended UE type in a frequency domain. The separated common CORESET dedicated to the extended UE type is referred to as a new common CORESET, and the common CORESET for the legacy UE type is referred to as a legacy common CORESET. The new common CORESET and the legacy common CORESET are associated with one or more of:
a mapping between a number of resource blocks of the new common CORESET and a number of resource blocks of the legacy common CORESET;
a mapping between a number of symbols of the new common CORESET and a number of symbols of the legacy common CORESET;
an offset between a starting resource block of the new common CORESET and a starting resource block of the legacy common CORESET;
an offset between a starting symbol of the new common CORESET and a starting symbol of the legacy common CORESET; and
an offset between a first symbol of an initial search space for type zero physical downlink control channel (PDCCH) in the new common CORESET and a first symbol of an initial search space for type zero PDCCH in the legacy common CORESET.

With reference to FIG. 10, the gNB 20 may configure a fixed mapping relationship between new CORESET #0 and legacy CORESET #0. For example, the fixed mapping relationship comprises frequency domain starting RB and/or RB size, time domain starting symbol and/or duration) for various combinations of numerologies (e.g., SSB subcarrier spacing (SCS), PDCCH SCS, and minimum channel bandwidth). The following table show an example of the mapping relationship.

TABLE 2

| | Legacy CORESET#0 | New CORESET#0 |
|---|---|---|
| Number of RBs | 24 | 24 − i (i = 0, . . . , 12) |
| N_{RB}^{CORESET} | 48 | 48 − i (i = 0, . . . , 24) |
| | 96 | 96 − i (i = 0, . . . , 48) |
| Number of Symbols | 1 | 1 |
| N_{symb}^{CORESET} | 2 | 2 − j(j = 0, 1) |
| | 3 | 3 − j(j = 0, 1, 2) |

| | |
|---|---|
| Frequency offset (RB): | ±m |
| an offset from the starting RB | A negative value indicates that the starting RB of new |
| index of the new | CORESET#0 is m RBs below the starting RB of legacy |
| CORESET#0 to the starting | CORESET#0. |
| RB index of the legacy | A positive value indicates that the starting RB of new |
| CORESET#0 | CORESET#0 is m RBs above the starting RB of legacy |
| | CORESET#0. |
| Time offset (symbol): | ±n |
| an offset from the starting | A negative value indicates that the starting symbol of new |
| symbol of the new | CORESET#0 is n RBs before the starting symbol of legacy |
| CORESET#0 to the starting | CORESET#0. |
| symbol of the legacy | A positive value indicates that the starting symbol of new |
| CORESET#0 | CORESET#0 is n RBs after the starting symbol of legacy |
| | CORESET#0. |

The parameter SearchSpaceZero indicates a search space index used to determine the Type 0 PDCCH search space monitoring occasion. The search space index determines a system frame number (SFN), a slot index, a first symbol index where Type0-PDCCH can be monitored. SFN and slot index are the same in new Searchspace #0 and legacy Searchspace #0. For first symbol index, the gNB 20 configures a fixed mapping between new searchspace #0 and legacy searchspace #0 because new CORESET #0 is adjusted in the time domain. A new Searchspace #0 may be configured/defined. An indication or configuration for the first symbol index of the new Searchspace #0 may be signaled from the gNB 10 to a RedCap UE, such as UE 10, explicitly or implicitly in a signal for deriving the first symbol index of the new Searchspace #0 from the first symbol index of the legacy Searchspace #0. The new searchspace #0 is a searchspace #0 in the enhanced CORESET #0, and the legacy searchspace #0 is a searchspace #0 in the legacy CORESET #0. The signal may be a MIB or a DL message, such as an information element (IE).

In this embodiment, three options represent three possible combinations of configuration:

Option 1: Configuration of CORESET #0 comprises:
Legacy CORE SET #0 configuration;
Legacy search space zero (SS #0) configuration;
New CORESET #0 configuration; and
New SS #0 configuration.
Configurations with a mapping relationship share the same index. The configurations of the new CORESET #0 and the new search space #0 are predefined in the specification, similar to the configuration tables in Chapter 13 of TS38.213.

Option 2: Configuration of CORESET #0 comprises:
Legacy CORESET #0 configuration;
Legacy SS #0 configuration;
The mapping relationship of new CORESET #0; and
The mapping relationship of new SS #0.
UE derives the new CORESET #0 and SS #0 configuration from the Legacy CORESET #0 and SS #0 configuration.
The mapping relationships are predefined in the specification.

Option 3: Configuration of CORESET #0 comprises:
Extension of the current CORESET #0 configurations; and
Extension of the current SS #0 configurations.
Current predefined configurations may be extended to include an extension that includes both legacy configurations of the legacy CORESET #0 and new configurations of the new CORESET #0, and configurations with a mapping relationship sharing the same index.

In an embodiment, the gNB 20 can provide a UE, such as the UE 10, 10a, or 10b, only one coresetzero index (i.e., an index of CORESET #0) and one searchspacezero index (i.e., an index of SS #0). For options 1 to 3, an index of CORESET #0 and an index of SS #0 of the UE is shown in Table 3. The UE determines whether to use legacy CORESET #0/SearchSpace #0 configuration or new CORESET #0/SearchSpace #0 configuration based on a UE type of the UE. Note that the embodiment does not preclude that UE can be provided with both legacy coresetzero/searchspacezero index and new coresetzero/searchspacezero index. For option 1, an index of CORESET #0 and an index of SS #0 of the UE is shown in Table 4.

TABLE 3

| PDCCH-ConfigSIB1 ::= SEQUENCE { | |
|---|---|
| controlResourceSetZero | ControlResourceSetZero, |
| searchSpaceZero | SearchSpaceZero , |

}

TABLE 4

| PDCCH-ConfigSIB1 ::= SEQUENCE { | |
|---|---|
| controlResourceSetZero | ControlResourceSetZero, |
| newControlResourceSetZero | ControlResourceSetZero , |
| searchSpaceZero | SearchSpaceZero , |
| newSearchSpaceZero | SearchSpaceZero |

}

Optionally, the gNB 20 may transmit an indication, such as an example shown in Table 5, in MIB, SIB1, or SIBx which indicates whether to enable or not the new CORESET #0. If the new CORESET #0 is disabled, all UEs including RedCap UEs can use the legacy CORESET #0. If the new CORESET #0 is enabled, the RedCap UEs may use the new CORESET #0.

```
TABLE 5
  MIB ::= SEQUENCE {
    ....
```

| | |
|---|---|
| newCoresetZeroandSerachsapceZeroInd | ENUMERATED {disable, enable} |

```
}
  SIB1 ::= SEQUENCE {
    ....
```

| | |
|---|---|
| newCoresetZeroandSerachsapceZeroInd | ENUMERATED {disable, enable} |

```
}
  SIBx ::= SEQUENCE {
    ....
```

| | |
|---|---|
| newCoresetZeroandSerachsapceZeroInd | ENUMERATED {disable, enable} |

}

In an embodiment, the gNB 20 provides no fixed mapping relationship for new CORESET #0 configuration and legacy CORESET #0 configuration for any combinations of numerologies (e.g., SSB SCS, PDCCH SCS, minimum channel bandwidth), so new configurations are directly provided by the gNB 20. A UE, such as the UE 10, 10a, or 10b, can be provided with both legacy coresetzero/searchspacezero index and new coresetzero/searchspacezero index, such as the example shown in Table 4. The UE determines whether to use the legacy CORESET #0/SearchSpace #0 configuration or new CORESET #0/SearchSpace #0 configuration based on a UE type of the UE.

Option 4: Configuration of CORESET #0 comprises:

```
Legacy CORESET#0 configuration;
Legacy SS#0 configuration;
New CORES ET#0 configuration; and
New SS#0 configuration.
  No mapping relationship between legacy configurations and new
  configurations are provided by the gNB 20. The configurations of the
  new CORESET#0 and the new Search Space#0 are predefined in the
  specification, similar to the configuration tables in Chapter 13 of TS
  38.213
```

Optionally, the gNB 20 may transmit an indication, such as an example shown in Table 5, in MIB, SIB1, or SIBx which indicates whether to enable or disable the new CORESET #0 and/or the new SS #. If the new CORESET #0 is disabled, all UEs including RedCap UEs may operate on the legacy CORESET #0. If the new CORESET #0 is enabled, the RedCap UEs may operate on the new CORESET #0.

### Configure New CORESET #0 in MIB:

With reference to FIG. 11, the gNB 20 configures new CORESET #0 in MIB. For Options 1 to 3: If the new CORESET #0 configuration is enabled by default, the new Searchspace #0 configuration is enabled as a consequence, and no fields is added in MIB to show the enabling of the new CORESET #0. If the new configurations of the new CORESET #0 are enabled by an indication, the indication is added in MIB. An example of the indication is shown in the IE in Table 4. The indication can be disabled or enabled later via MIB, SIB, SIBx, or a RRC message after the gNB 20 identifies the UE type of a UE. One or more RedCap UEs, such as the UE 10 and/or 10a, receive the indices controlResourcesetZero and searchspaceZero in MIB, and then based on UE type of the one or more RedCap UEs and the indices, get or derive the configurations of CORESET #0 and SS #0.

For Options 1 and 4: One or more RedCap UEs, such as the UE 10 and/or 10a, determine which CORESET #0 and SS #0 configuration will be adopted according to the indices controlResourcesetZero and searchspaceZero for RedCap UE in MIB. Meanwhile, the enable/disable indication mentioned above can also be applied in Options 1 and 4.

When RedCap UEs receive the enabling configuration of new CORESET #0, the RedCap UEs will receive SIB1, SIBx, msg2, msg4, msgB, SSB and paging in new CORESET #0 as the initial DL BWP.

Optionally, the RedCap UEs may initially receive from the gNB 20 one or more DL messages, such as SIB1, SIBx, msg2, msg4, msgB, SSB, and paging, in the legacy CORESET #0, and subsequently one or more DL messages in new CORESET #0. In other word, when the new initial DL BWP cannot be used immediately after being configured, the RedCap UEs may initially receive one or more DL messages in the legacy CORESET #0, and subsequently, receive one or more DL messages in new CORESET #0 from the gNB 20.

With reference to FIG. 11, SIB1 and non-on-demand SIBx are broadcast messages. When the gNB 20 doesn't recognize the UE type of a UE in transmitting SIB1 and non-on-demand SIBx, so the gNB 20 may transmit SIB1 and non-on-demand SIBx in the legacy CORESET #0 and new CORESET #0 that is enabled.

If new CORESET #0 is enabled, the RedCap UEs and non-RedCap UEs receive SIB1 in new CORESET #0 and legacy CORESET #0 respectively. Furthermore, the RedCap UEs can receive SIB1 in Legacy CORESET #0.

If new CORESET #0 is disabled, the RedCap UEs and non-RedCap UEs receive SIB1 in the legacy CORESET #0.

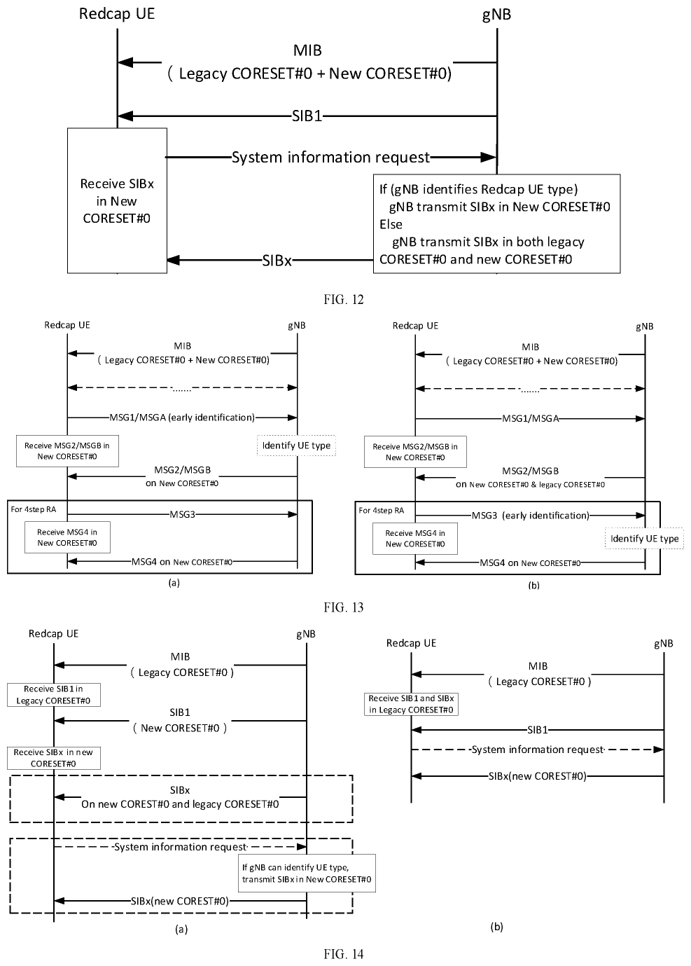

FIG. 12 shows an example of on demand SIBx. For on-demand SIBx, if the gNB 20 can recognize a RedCap UE type of a UE from the message that carries system information request from the UE, the gNB 20 transmits on-demand SIBx in new CORESET #0. Note that the embodiment does not preclude that the gNB 20 also transmits the on-demand SIBx in the legacy CORESET #0. the RedCap UEs receive SIBx in new CORESET #0. Note that the embodiment does not preclude that the gNB 20 transmits SIBx only in the legacy CORESET #0, and the RedCap UEs receive SIBx in the legacy CORESET #0.

If the gNB 20 does not recognize a RedCap UE type of the UE, the gNB 20 transmits SIBx both in the legacy CORESET #0 and in new CORESET #0. The RedCap UEs receive SIBx in new CORESET #0. Optionally, the gNB 20 transmits SIBx only in the legacy CORESET #0, and the RedCap UEs receive SIBx in the legacy CORESET #0.

FIG. 13 shows examples of msg2, msg4, and msgB transmission.
(1) For transmission of msg2, msg4, and/or msgB, if the gNB 20 recognizes the RedCap UE type of the UE through early identification based on a separate initial UL BWP, a separate preamble, or a separate Rach occasion of the UE, the gNB 20 may transmit msg2, msg4, and/or msgB in new CORESET #0. The early identification refers to recognition of the extended UE type (e.g., RedCap UE type) of one or more UEs by the gNB. At least one of a separate initial uplink BWP, a separate random access channel (RACH) preamble, or a separate RACH occasion of the extended UE type is used for recognition of the extended UE type by the base station. If the gNB 20 does not recognize the RedCap UE type of the UE, the gNB 20 transmits msg2, msg4, and/or msgB in both the legacy CORESET #0 and the new CORESET #0. The RedCap UEs receive the DL message msg2, msg4, and/or msgB in new CORESET #0.
(2) The gNB 20 can transmit SSB and paging in new CORESET #0 or legacy CORESET #0. Correspondingly, the RedCap UEs receive the SSB and paging in new CORESET #0 or legacy CORESET #0.

### Configure New CORESET #0 in SIB1 or SIBx:

With reference to FIG. 14, the gNB 20 configures new CORESET #0 in SIB1 and SIBx. For Options 1 to 3: If the new configurations are enabled by default, no field is added into SIB1 and/or SIBx. If the new configurations are enabled by an indication, the gNB 20 may add the indication in SIB1. An example of the indication is shown in Table 6. The indication can be disabled later via MIB, SIB, SIBx, or an RRC message after the gNB 20 identifies the UE type. The RedCap UEs receive the indices controlResourcesetZero and searchspaceZero in SIB1 or SIBx, and then based on the UE types of the RedCap UEs and the indices, get or derive the configurations of CORESET #0 and SS #0.

TABLE 6
SIB1 | SIBx ::= SEQUENCE {
....

| | |
|---|---|
| newCoresetZeroandSearchspaceZeroInd | ENUMERATED {disable, enable} |
| } | |

For Options 1 and 4: A RedCap UE directly determines which CORESET #0 and SS #0 configuration will be adopted according to the indices of controlResourcesetZero and searchspaceZero for the RedCap UE in SIB1 or SIBx. The parameters newcontrolResourcesetZero and newsearchspaceZero in Table 7 are examples of the indices controlResourcesetZero and searchspaceZero. Meanwhile, the enable/disable indication aforementioned can also be applied in Options 1 and 4.

TABLE 7

| SIB1 \| SIBx ::= SEQUENCE { | |
|---|---|
| ..., | |
| newControlResourceSetZero | ControlResourceSetZero, |
| newSearchSpaceZero | SearchSpaceZero |

}

When the RedCap UEs receive the configuration enabling the new CORESET #0, such as the indication showing the enabling of the new CORESET #0, the RedCap UEs may receive SIBx, msg2, msg4, msgB, SSB and paging in new CORESET #0 as the initial DL BWP.

RedCap UEs may initially receive one or more DL messages, such as SIB1, SIBx, msg2, msg4, msgB, SSB, and paging, in the legacy CORESET #0, and subsequently one or more DL messages in new CORESET #0 from the gNB 20. In other word, when the new initial DL BWP cannot be used immediately after being configured, the RedCap UEs may initially receive one or more DL messages in the legacy CORESET #0, and subsequently, receive one or more DL messages in new CORESET #0 from the gNB 20.

With reference to FIG. 13, when the gNB 20 doesn't recognize the UE type of a UE in transmitting non-on-demand SIBx, so the gNB 20 may transmit non-on-demand SIBx in the legacy CORESET #0 and new CORESET #0 that is enabled.

If new CORESET #0 is enabled, the RedCap UEs and non-RedCap UEs receive SIBx in new CORESET #0 and legacy CORESET #0 respectively. Furthermore, the RedCap UEs can receive SIBx in Legacy CORESET #0.

If new CORESET #0 is disabled, the RedCap UEs and non-RedCap UEs receive SIBx in the legacy CORESET #0.

With reference to FIG. 14, on-demand SIBx, if the gNB 20 can recognize a RedCap UE type of a UE from the message that carries system information request from the UE, the gNB 20 transmits on-demand SIBx in new CORESET #0. Note that the embodiment does not preclude that the gNB 20 also transmits the on-demand SIBx in the legacy CORESET #0. the RedCap UEs receive SIBx in new CORESET #0. Note that the embodiment does not preclude that the gNB 20 transmits SIBx only in the legacy CORESET #0, and the RedCap UEs receive SIBx in the legacy CORESET #0.

If the gNB 20 does not recognize a RedCap UE type of the UE, the gNB 20 transmits SIBx both in the legacy CORESET #0 and in new CORESET #0. The RedCap UEs receive SIBx in new CORESET #0. Optionally, the gNB 20 transmits SIBx only in the legacy CORESET #0, and the RedCap UEs receive SIBx in the legacy CORESET #0.

With reference to FIG. 15, for msg2, msg4, and/or msgB, if the gNB 20 recognizes the RedCap UE type of the UE through early identification based on a separate initial UL BWP, a separate preamble, or a separate Rach occasion of the UE, the gNB 20 may transmit msg2, msg4, and/or msgB in new CORESET #0. If the gNB 20 does not recognize the RedCap UE type of the UE, the gNB 20 may transmit msg2, msg4, and/or msgB in both the legacy CORESET #0 and the new CORESET #0. The RedCap UEs receive the DL messages in new CORESET #0.
(3) The gNB 20 can transmit SSB and paging in new CORESET #0 or legacy CORESET #0. Correspondingly, the RedCap UEs receive the SSB and paging in new CORESET #0 or legacy CORESET #0.

### CORESET #0 Extension:

FIG. 16 shows examples of CORESET #0 extension. When the common CORESET for the extended UE type is an extension of the common CORESET for the legacy UE type, configuration of the common CORESET for the extended UE type comprises a size j of the common CORESET for the extended UE type in a time domain and a size i of the common CORESET for the extended UE type in a frequency domain.

The common CORESET for the extended UE type and the common CORESET for the legacy UE type are associated with one or more of:
an offset between a starting resource block of the common CORESET for the extended UE type and a starting resource block of the common CORESET for the legacy UE type;
an offset between a starting symbol of the common CORESET for the extended UE type and a starting symbol of the common CORESET for the legacy UE type; and
an offset between a first symbol of an initial search space for type zero physical downlink control channel (PDCCH) in the common CORESET for the extended UE type and a first symbol of an initial search space for type zero PDCCH in the common CORESET for the legacy UE type.

CORESET #0 parts 51-58 are CORESET #0 extensions, and CORESET #0 parts 41-48 are legacy parts. For example, the CORESET #0 parts 51 is an extension, a new part, or an additional part of a CORESET #0 401, and the CORESET #0 parts 41 is a legacy part of the CORESET #0 401. Similarly, the CORESET #0 parts 52-58 are extensions of CORESET #0 402-408 respectively, and the CORESET #0 parts 42-48 are legacy parts of the CORESET #0 402-408 respectively.

The RedCap UEs and non-RedCap UEs share the same legacy initial DL BWP, but the gNB 20 configure an additional part of legacy CORESET #0 for redcap UEs. The additional part is an extension of resources for legacy CORESET #0. As a consequence, the additional part (e.g., CORESET #0 part 51) and a legacy part (e.g., CORESET #0 part 41) of a legacy CORESET #0 (e.g., CORESET #0 401) share the same index. As shown in FIG. 16, the additional part can be FDMed or TDMed with the legacy part, and the entire new CORESET #0 are contained in the legacy initial DL BWP.

### The Time-Frequency Relationship of Legacy Part and Additional Part of CORESET #0:

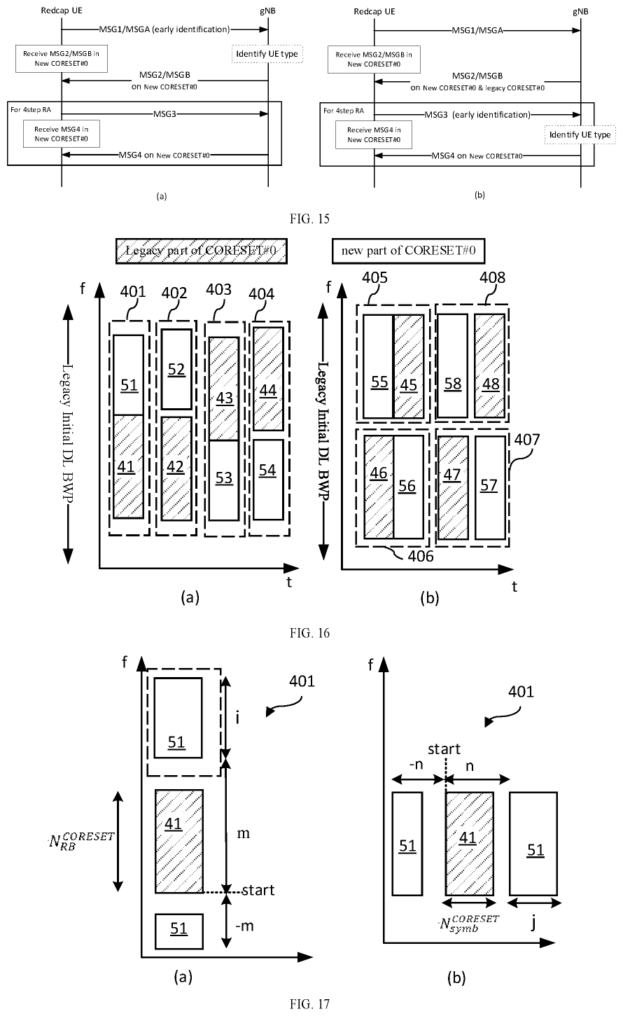

With reference to FIG. 17, when the common CORESET for the extended UE type is an extension of the common CORESET for the legacy UE type, configuration of the common CORESET for the extended UE type comprises a size j of the common CORESET for the extended UE type in a time domain and a size i of the common CORESET for the extended UE type in a frequency domain. The common CORESET for the extended UE type and the common CORESET for the legacy UE type are associated with one or more of:
an offset between a starting resource block of the common CORESET for the extended UE type and a starting resource block of the common CORESET for the legacy UE type;
an offset between a starting symbol of the common CORESET for the extended UE type and a starting symbol of the common CORESET for the legacy UE type; and
an offset between a first symbol of an initial search space for type zero physical downlink control channel (PDCCH) in the common CORESET for the extended UE type and a first symbol of an initial search space for type zero PDCCH in the common CORESET for the legacy UE type.

Some additional or new indication or configuration items may be added into current predefined configurations (such as the tables in TS 38.213 chapter 13) of CORESET #0. The additional indication or configuration items of the enhanced CORESET #0 may comprise:
(1). Additional number of RBs and/or the frequency offset from the starting RB of the additional part (e.g., part 51) to the starting RB of a legacy part (e.g., part 41).
   Additional number of RBs (i): determines the size of the additional part (e.g., part 51) in frequency domain.
   The frequency offset (±m): determines the frequency offset from the starting RB of the additional part (e.g., part 51) to the starting RB of the legacy part (e.g., part 41).
   If this item does not exist, then the two parts are next to each other. The additional part (e.g., part 51) is either above or below the legacy part (e.g., part 41).
   A negative value indicates that the starting RB of the additional part (e.g., part 51) is m RBs below the starting RB of the legacy part (e.g., part 41).
   A positive value indicates that the starting RB of the additional part (e.g., part 51) is m RBs above the starting RB of the legacy part (e.g., part 41).
(2). Additional number of symbols and/or or the time offset from the starting symbol of the additional part (e.g., part 51) to the starting symbol of the legacy part (e.g., part 41).
   Additional number of symbols (j): determines the size of the additional part (e.g., part 51) in time domain.
   The time offset (±n): determines the time offset from the starting symbol of the additional part (e.g., part 51) to the starting symbol of the legacy part (e.g., part 41).
   If this item does not exist, then the two parts are next to each other. The additional part (e.g., part 51) is either before or after the legacy part (e.g., part 41).
   A negative value indicates that the starting symbol of the additional part (e.g., part 51) is n symbols before the starting symbol of the legacy part (e.g., part 41).
   A positive value indicates that the starting RB of the additional part (e.g., part 51) is n symbols after the starting symbol of the legacy part (e.g., part 41).

The parameter SearchSpaceZero indicates a search space index used to determine the Type 0 PDCCH search space monitoring occasion. The search space index determines a system frame number (SFN), a slot index, a first symbol index where Type0-PDCCH can be monitored. The extension of CORESET #0 does not affect the monitoring of SFN and slot index. If the extension is in time domain extension, searchspace #0 may be adjusted correspondingly. An indication or configuration for the first symbol index of the extension of CORESET #0 may be signaled from the gNB 10 to a RedCap UE, such as UE 10, explicitly or implicitly in a signal for deriving the first symbol index of in new searchspace #0 of the extension of CORESET #0 from the first symbol index of legacy searchspace #0 in the legacy CORESET #0. The signal may be a MIB or a DL message, such as an information element (IE).

In this approach, the UE is provided only one controlresoucesetzero index and one searchspacezero index, and then determines whether to use legacy part or additional part configuration based on its UE type.

Optionally, the gNB 20 may transmit an indication in MIB, SIB, and/or SIBx that indicates whether to or enable or disable the additional part. If the additional part is disabled, all UEs may use the legacy part; if the additional part is enabled, the RedCap UEs can use the additional part. Table 8 shows an example of the indication in MIB, SIB, and/or SIBx.

TABLE 8
MIB ::= SEQUENCE {
....

| | |
|---|---|
| additionalPartofCoresetZeroInd | ENUMERATED {disable, enable} |

}
SIB1::= SEQUENCE {
....

| | |
|---|---|
| additionalPartofCoresetZeroInd | ENUMERATED {disable, enable} |

}
SIBx ::= SEQUENCE {
....

| | |
|---|---|
| additionalPartofCoresetZeroInd | ENUMERATED {disable, enable} |
| } | |

If the configuration of the additional part is enabled by default, no fields is added in MIB, SIB1, and/or SIBx. If the configuration of the additional part is enabled by an indication, the gNB 20 may add the indication in MIB, SIB1, and/or SIBx, of which an example is shown in Table 8. The indication can be disabled later via MIB, SIB, SIBx, or an RRC message after the gNB 20 identifies the UE type. The RedCap UEs receive the indices of controlResourcesetZero and searchspaceZero in MIB, and then based on UE types of the RedCap UEs and the indices, get or derive the configuration of the additional part of CORESET #0 and SS #0.

When RedCap UEs receive the configuration enabling the new CORESET #0, the RedCap UEs may receive SIB1, SIBx, msg2, msg4, msgB, SSB, and/or paging in the new CORESET #0 as the initial DL BWP.

RedCap UEs may initially receive one or more DL messages, such as SIB1, SIBx, msg2, msg4, msgB, SSB, and paging, in the legacy CORESET #0, and subsequently one or more DL messages in new CORESET #0 from the gNB 20. In other word, when the new initial DL BWP cannot be used immediately after being configured, the RedCap UEs may initially receive one or more DL messages in the legacy CORESET #0, and subsequently, receive one or more DL messages in new CORESET #0 from the gNB 20. The procedures are similar to those aforementioned.

### Part of the Existing CORESET #0 for RedCap UEs:

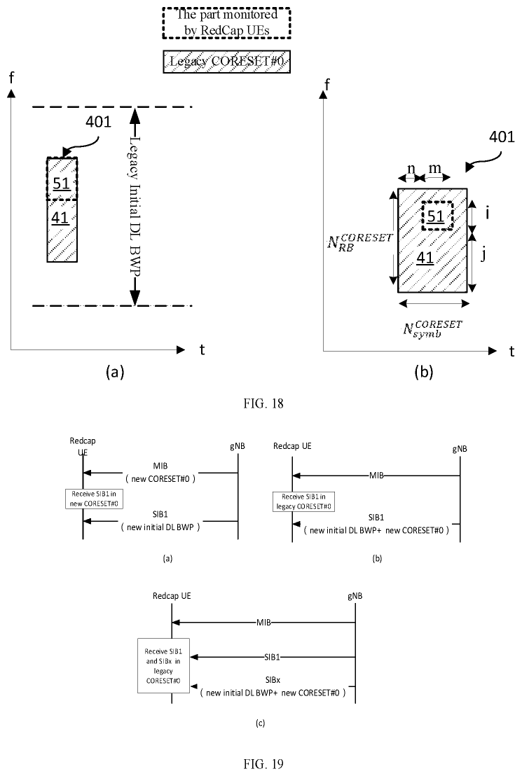

FIG. 18 shows examples of a part of legacy CORESET #0 for the extended UE type. The enhanced common CORESET (CORESET #0) for the extended UE type may be a part of a common CORESET (CORESET #0) for the legacy UE type. When the common CORESET for the extended UE type is a part of the common CORESET for the legacy UE type, configuration of the common CORESET for the extended UE type comprises a size (e.g., m in FIG. 18) of the common CORESET for the extended UE type in a time domain and a size (e.g., i in FIG. 18) of the common CORESET for the extended UE type in a frequency domain. The common CORESET for the extended UE type and the common CORESET for the legacy UE type are associated with one or more of:
an offset (e.g., j in FIG. 18) between a starting resource block of the common CORESET for the extended UE type and a starting resource block of the common CORESET for the legacy UE type;
an offset (e.g., n in FIG. 18) between a starting symbol of the common CORESET for the extended UE type and a starting symbol of the common CORESET for the legacy UE type; and
an offset between a first symbol of an initial search space for type zero physical downlink control channel (PDCCH) in the common CORESET for the extended UE type and a first symbol of an initial search space for type zero PDCCH in the common CORESET for the legacy UE type.

The part may contain the entire frequency domain but a part of the time domain of the legacy CORESET #0, or the entire time domain but a part of the frequency domain of the legacy CORESET #0, or a part of the time domain and a part of the frequency domain of the legacy CORESET #0. The RedCap UEs only monitor on the part of the legacy CORESET #0, such as the part 51 in FIG. 18, rather than the entire legacy CORESET #0 401. The RedCap UEs may share the part (e.g., part 51) with non-RedCap UEs, or exclusively use the part (e.g., part 51) of the legacy CORESET #0.

Some additional or new indication or configuration items may be added into current predefined configurations (such as the tables in TS 38.213 chapter 13) of CORESET #0. The additional indication or configuration items of the enhanced CORESET #0 may be signaled in MIB and/or SIB, and may comprise:
(1). The number of RBs of the RedCap part and/or the frequency offset from the starting RB of a legacy part.
   The number of RBs (i) of the RedCap part: determines the size of the RedCap part in frequency domain.
   The frequency offset (j): determines the frequency offset from the starting RB of the RedCap part to the starting RB of the legacy part.
(2). The number of the RedCap part symbols and/or or the time offset from the starting symbol of the number of the RedCap part to the starting symbol of the legacy part.
   Additional number of symbols (m): determines the size of the RedCap part in time domain.
   The time offset (n): determines the time offset from the starting symbol of the RedCap part to the starting symbol of the legacy part.
The parameter SearchSpaceZero indicates a search space index used to determine the Type 0 PDCCH search space monitoring occasion. The search space index determines a system frame number (SFN), a slot index, a first symbol index where Type0-PDCCH can be monitored. The extension of CORESET #0 does not affect the monitoring SFN and slot index. If the RedCap part is different from legacy CORESET #0, searchspace #0 may be adjusted correspondingly. An indication or configuration for the first symbol index of the searchspace #0 in the part of CORESET #0 may be signaled from the gNB 10 to a RedCap UE, such as UE 10, explicitly or implicitly in a signal for deriving the first symbol index of the new searchspace #0 in the part of CORESET #0 from the first symbol index of the legacy searchspace #0 in the legacy CORESET #0 is added The signal may be a MIB or a DL message, such as an information element (IE).

The configuration, enablement modes (e.g., enabling/disabling), and procedures of the embodiment are similar to those described in embodiments of new CORESET #0.

### Separate Initial DL BWP for RedCap UEs:

In TDD case, considering that a separate initial UL BWP is configured for RedCap UEs, a separate DL BWP can be configured for center frequency alignment or traffic offload. In FDD case, a separate DL BWP can be configured for traffic offloading and the initial DL/UL BWP pairing.

The separate initial DL BWP for RedCap UEs, referred to as a new initial DL BWP hereafter, may have the same or different center frequency as the corresponding new initial UL BWP. For TDD case, the same center frequency is preferred.

Optionally, the gNB 20 may transmit to UEs an indication in SIB1/SIBx that indicates whether to enable or disable the new initial DL BWP. If the new initial DL BWP is disabled, all UEs including the RedCap UEs operate on the legacy initial DL BWP, i.e., all UEs including the RedCap UEs receive DL messages on the legacy initial DL BWP. If the new initial DL BWP is enabled, the RedCap UEs operate on the new initial DL BWP, i.e., the RedCap UEs receive DL messages on the legacy initial DL BWP.

The indication for enabling or disabling the initial downlink bandwidth part for the extended UE type is transmitted in a MIB, a SIB1, a SIBx, or an RRC message. When t the initial downlink bandwidth part for the extended UE type is enabled, one or more downlink messages for the extended UE type is transmitted in the initial downlink bandwidth part for the extended UE type. When the initial downlink bandwidth part for the extended UE type is not enabled, one or more downlink messages for the extended UE type is transmitted in the common CORESET for the legacy UE type. One or more downlink messages for the extended UE type is transmitted in both of the initial downlink bandwidth part for the extended UE type and common CORESET for the legacy UE type before the base station recognizes the extended UE type. One or more downlink messages for the extended UE type is transmitted in the initial downlink bandwidth part for the extended UE type upon the base station recognizes the extended UE type.

For example, when the enhanced common CORESET for the extended UE type is enabled, a first downlink message is transmitted in the common CORESET for the legacy UE type from the gNB 20 to the UE 10, a second downlink message is transmitted in the enhanced common CORESET for the extended UE type from the gNB 20 to the UE 10, and a third downlink message is transmitted in the initial downlink bandwidth part for the extended UE type from the gNB 20 to the UE 10. Alternatively, when the enhanced common CORESET for the extended UE type is not enabled, the first downlink message and the second downlink message are transmitted in the common CORESET for the legacy UE type from the gNB 20 to the UE 10, and the third downlink message is transmitted in the initial downlink bandwidth part for the extended UE type from the gNB 20 to the UE 10. The initial downlink bandwidth part for the extended UE type may be enabled by the first downlink message or the second downlink message. The enhanced common CORESET for the extended UE type may be enabled by the first downlink message. The first downlink message may comprise an SSB, the second downlink message may comprise a SIB with an index one (SIB1) or a SIB with a greater index (SIBx), and the third downlink message may comprise a random access downlink message, and the random access downlink message comprises msg2, msg4, or msgB.

The new initial DL BWP is associated with a CORESET #0. The embodiments for sharing the entire legacy CORESET #0 and embodiments for enhanced CORESET #0, such as a new CORESET #0, a legacy CORESET #0 extension, a legacy CORESET #0 part may be applied to the CORESET #0 associated new initial DL BWP.

The configuration, enablement modes (e.g., enabling/disabling), and procedures of the CORESET #0 associated new initial DL BWP in the embodiment are similar to those described in the aforementioned embodiments.

The gNB 20 may set the configuration of the initial DL BWP in SIB1 or SIBx. The following tables and figures provide some examples for the configurations of the new initial DL BWP and the enhanced CORESET #0. Note that the case of sharing the entire legacy CORESET #0 is not included.

TABLE 9
initial

| Enhanced CORESET#0 | new initial DL BWP |
|---|---|
| MIB | SIB1 |
| MIB | SIBx |
| SIB1 | SIB1 |
| SIB1 | SIBx |
| SIBx | SIBx |

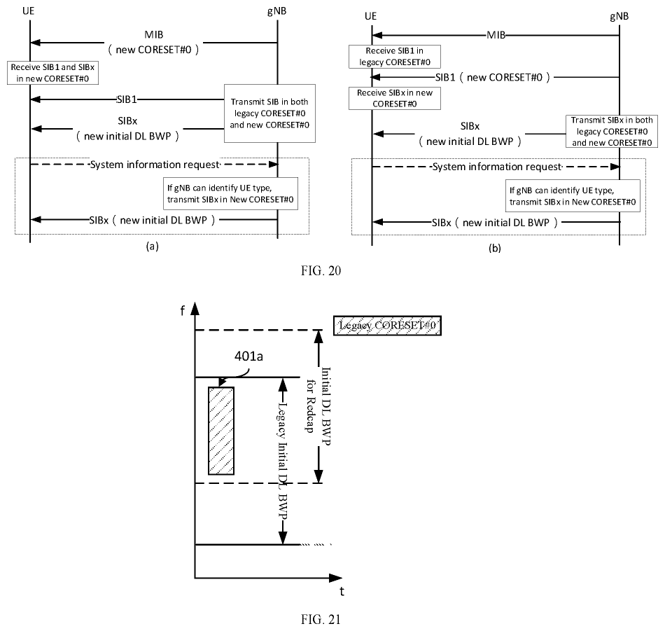

FIG. 19 and FIG. 20 provide examples of the configuration of separate CORESET #0 and separate initial DL BWP. After the configuration/enablement of new initial DL BWP, messages can operate in new initial DL BWP, i.e., the gNB 20 can transmit DL messages to the RedCap UEs in the new initial DL BWP.

In the case of sharing the entire legacy CORESET #0 with non-RedCap UEs, the enhanced CORESET #0 or the legacy CORESET #0 can be actually used as the initial DL BWP for RedCap UEs before and during the random access processing as shown in Table 1. When the enhanced CORESET #0 or the legacy CORESET #0 is used as the initial DL BWP for RedCap UEs before and during the random access processing, the new initial DL BWP becomes effective only after random access. Before receiving the configuration of new CORESET #0, the gNB 20 transmits DL messages in the legacy CORESET #0, and RedCap UE receiving the DL messages in the legacy CORESET #0. For the cases of non-sharing legacy CORESET #0 (part or entire):
If the gNB 20 does not recognize the RedCap UE type of one or more RedCap UEs, the gNB 20 transmits DL messages (e.g., SIB1, SIBx, msg2/4/B, and/or paging) at least in the legacy CORESET #0, or at the same time in the enhanced CORESET #0 and the legacy CORESET #0. The RedCap UEs receive these DL messages in the legacy CORESET #0 or enhanced CORESET #0.
If the gNB 20 recognizes the RedCap UE type of one or more RedCap UEs, the gNB 20 transmits relevant DL messages in enhanced CORESET #0 or legacy CORESET #0, and the RedCap UEs receives the relevant DL messages in enhanced CORESET #0 or legacy CORESET #0.
The FIG. 20 shows examples in which the gNB 20 selects a CORESET #0 and transmits messages in the selected CORESET #0, and the RedCap UEs receive messages in the selected CORESET #0 when a new CORESET #0 is configured in MIB.

Alternatively, after the configuration of the new initial DL BWP, messages can be operated in new initial DL BWP (i.e., the gNB 20 can transmit DL messages to the RedCap UEs in the new initial DL BWP) even before or during or after random access.
If the gNB 20 does not recognize RedCap UE type, the gNB 20 transmits DL messages at least in the legacy CORESET #0, or at the same time in the new initial DL BWP and the legacy CORESET #0. The RedCap UEs receive these DL messages in the legacy CORESET #0 or the new initial DL BWP.
If the gNB 20 recognizes the RedCap UE type of one or more RedCap UEs, the gNB 20 transmits relevant DL messages in new initial DL BWP, and the RedCap UEs receives the relevant DL messages in new initial DL BWP.

Alternatively, the gNB 20 transmits these DL messages in different resources. For example, the gNB 20 transmits the SSB in the legacy CORESET #0, SIB1&SIBx in enhanced CORESET #0, and msg2, msg4, or msgB in new initial DL BWP. Accordingly, the RedCap UE receives messages at different resources.

### Sharing the Entire CORESET #0:

FIG. 21 shows an example of sharing one CORESET #0 (e.g., 401a) by a new initial DL BWP and a legacy initial DL BWP. In this embodiment, RedCap UEs and non-RedCap UEs have a separate initial DL BWP but share the entire legacy CORESET #0. The separate initial DL BWP for RedCap UEs (referred to as new initial DL BWP) is configured in SIB1, and the new initial DL BWP is associated with the legacy CORESET #0. The new DL BWP and the Legacy DL BWP can be partially overlapped or completely separated in the frequency domain. The bandwidth of new initial DL BWP is preferably not to exceed the maximum bandwidth of RedCap UEs. Note that the embodiment does not preclude the case that the bandwidth of new initial DL BWP exceeds maximum bandwidth of RedCap UEs.

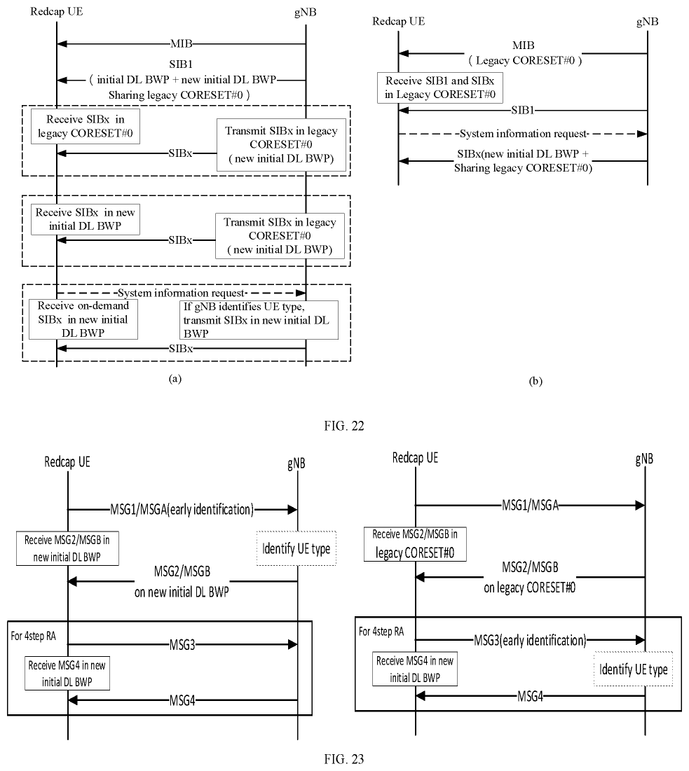

FIG. 22 shows examples of the configuration of new initial DL BWP and the procedure of SIB. The new initial DL BWP may or may not contain a CORESET #0 on the frequency domain. The new initial DL BWP may be represented by a parameter newnitialDownlinkBWP, and the legacy initial DL BWP may be represented by a parameter initialDownlinkBWP. The gNB 20 may configure and transmit the newnitialDownlinkBWP and legacy initialDownlinkBWP in a broadcast message, such as SIB and/or SIBx, or a DL message. An example of the SIB1 and an example of the SIBx is shown in Table 10 and Table 11. The newInitialDownlinkBWP and legacy initialDownlinkBWP are associated with the same controlResourcesetZero and search spaceZero. If the field “newInitialDownlinkBWP” is absent, the RedCap UEs may share the legacy initial DL BWP with non-RedCap UEs.

TABLE 10

| SIB1::= SEQUENCE { | |
|---|---|
| ..., | |
| initialDownlinkBWP | BWP-DownlinkCommon, |
| newInitialDownlinkBWP | BWP-DownlinkCommon , |

}

TABLE 11

```
  SIBx::= SEQUENCE {
  ...,
  newInitialDownlinkBWP BWP-DownlinkCommon ,
}
```

Optionally, the gNB 20 may transmit to UEs an indication in SIB1/SIBx that indicates whether to enable or disable the new initial DL BWP. If the new initial DL BWP is disabled, all UEs including the RedCap UEs operate on the legacy initial DL BWP, i.e., all UEs including the RedCap UEs receive DL messages on the legacy initial DL BWP. If the new initial DL BWP is enabled, the RedCap UEs operate on the new initial DL BWP, i.e., the RedCap UEs receive DL messages on the legacy initial DL BWP. The indication can be disabled or enabled later via MIB, SIB, SIBx, or RRC after the gNB 20 identifies the UE type. Table 12 shows an example of the indication.

TABLE 12

| SIB1 ::= SEQUENCE { | |
|---|---|
| .... | |
| newInitialDLBwpInd | ENUMERATED {disable, enable} |
| } | |
| SIBx ::= SEQUENCE { | |
| .... | |
| newInitialDLBwpInd | ENUMERATED {disable, enable} |

}

After the configuration/enablement of new initial DL BWP, the DL messages (SIBx, msg2, msg4, msgB, etc.) can be operated in the new initial DL BWP (i.e., the gNB 20 can transmit DL messages to the RedCap UEs in the new initial DL BWP).

Optionally, the DL messages are still operated in the legacy CORESET #0 before and during random access. This means that the new initial DL BWP may not be used immediately after being configured or enabled. In other word, when the new initial DL BWP cannot be used immediately after being configured, the RedCap UEs may initially receive one or more DL messages in the legacy CORESET #0, and subsequently, receive one or more DL messages in new initial DL BWP from the gNB 20.

Optional, a part of the DL messages is operated in new initial DL BWP, and subsequently a part of the DL messages is operated in the legacy CORESET #0.

The following mainly describes the case in which initial DL BWP is in effect during or before random access.
(1) With reference to FIG. 22, when the new initial DL BWP is configured in SIB1, and the gNB 20 doesn't recognize the type of UE in transmitting non-on-demand SIBx, the gNB 20 transmits the non-on-demand SIBx at least in the legacy CORESET #0.
   If the new initial DL BWP is enabled, the gNB 20 can transmit SIBx in the new initial DL BWP and in the legacy CORESET #0 at the same time. The RedCap UEs receive SIBx in the legacy CORESET #0 or the new initial DL BWP.
   If the new initial DL BWP is disabled, the SIBx is operated in the legacy CORESET #0, i.e., the gNB 20 can transmit SIBx in the legacy CORESET #0, and the RedCap UEs receive SIBx in the legacy CORESET #0.
(2) With reference to FIG. 22, for on-demand SIBx, if the gNB 20 recognizes the RedCap UE type of one or more RedCap UEs from the information that carrying a system information request:
   The gNB 20 transmits on-demand SIBx in the new initial DL BWP. Note that the embodiment does not preclude that the gNB 20 transmits the on-demand SIBx in the new initial DL BWP and in the legacy CORESET #0. The RedCap UEs receive the SIBx in new initial DL BWP.
   Note that the embodiment does not preclude that the gNB 20 transmits SIBx only in the legacy CORESET #0, and the RedCap UEs receive SIBx in the legacy CORESET #0.
   If the gNB 20 does not recognizes the RedCap UE type of one or more RedCap UEs from the information that carrying a system information request, the gNB 20 transmits on-demand SIBx at least in the legacy CORESET #0;
   The gNB 20 can transmit on-demand SIBx in the new initial DL BWP and the legacy CORESET #0 at the same time. The RedCap UEs receive the on-demand SIBx in the legacy CORESET #0 or new initial DL BWP.
(3) FIG. 23 shows examples of a random access (RA) procedure. For msg2, msg4, and/or msgB, if the gNB 20 recognizes the RedCap UE type by early identification based on a separate initial UL BWP, a separate preamble, or a separate Rach occasion of the UE, the gNB 20 transmits the DL messages msg2, msg4, and/or msgB at least in new initial DL BWP. Note that the embodiment does not preclude that the gNB 20 transmits the DL messages msg2, msg4, and/or msgB in both new CORESET #0 and legacy CORESET #0 or only in the legacy CORESET #0.
   If the gNB 20 does not recognize RedCap UE type, the gNB 20 transmits the DL messages msg2, msg4, and/or msgB at least in the legacy CORESET #0. Note that the embodiment does not preclude that the gNB 20 transmits the DL messages msg2, msg4, and/or msgB in both new CORESET #0 (new initial DL BWP) and legacy CORESET #0.
(4) The gNB 20 transmits the messages SSB and paging messages in the legacy CORESET #0 and/or the new initial DL BWP.

### Sharing Part of the Legacy CORESET #0:

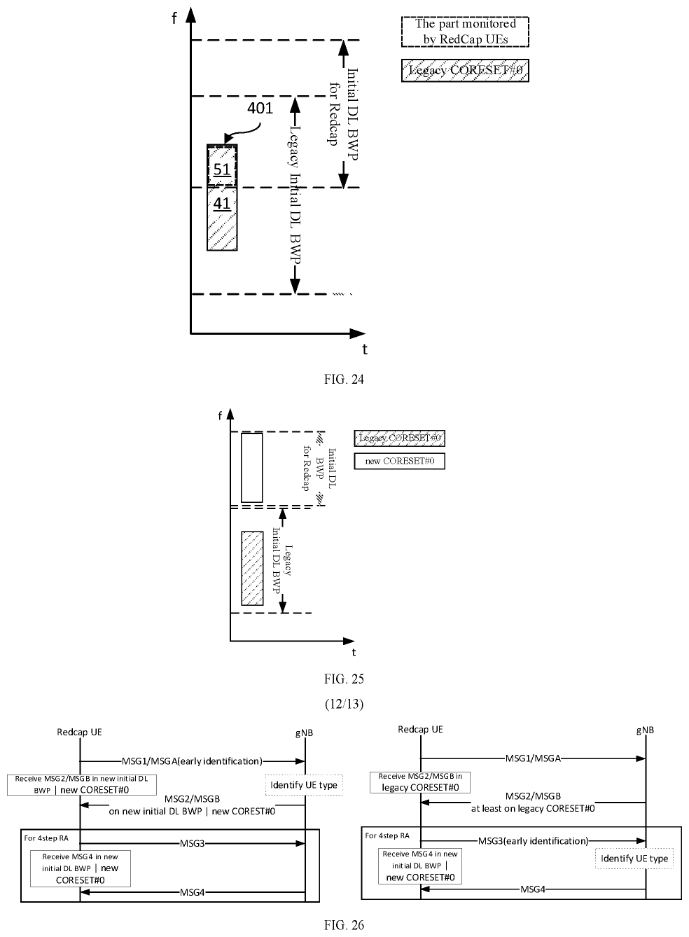

FIG. 24 shows an example of one CORESET #0 shared by a separate initial DL BWP for RedCap UEs and a legacy initial DL BWP for non-RedCap UEs. In this embodiment, the RedCap UEs and non-RedCap UEs have different initial DL BWPs but share the part of CORESET #0. The separate initial DL BWP for RedCap UEs (referred to as new initial DL BWP) may be configured by the gNB 20 in SIB1 or SIBx, and the new initial DL BWP is associated with the legacy CORESET #0. The new DL BWP and the legacy DL BWP may be partially overlapped or completely separated in the frequency domain.

The new Initial DL BWP may or may not contain the legacy CORESET #0 in the frequency domain. The newInitialDownlinkBWP and the initialDownlinkBWP are associated with the same controlResourcesetZero and searchspaceZero. If the field “newInitialDownlinkBWP” is absent, the RedCap UEs may share the legacy initial DL BWP with non-RedCap UEs.

The configuration and enablement mode (e.g., enabling/disabling) of the part of the legacy CORESET #0 for RedCap UEs are similar to the aforementioned embodiments. The configuration and enablement mode (e.g., enabling/disabling) of the ne w initial DL BWP are similar to the aforementioned embodiments. The procedure of message transmission is similar to the aforementioned embodiments.

### Separate CORESET #0 for RedCap UEs:

FIG. 25 shows example of different common CORESETs (CORESET #0) with different initial DL BWPs. In this embodiment, RedCap UEs and non-RedCap UEs have separated initial DL BWPs and separated common CORESETs. The separate initial DL BWP (the new initial DL BWP) and the separate CORESET #0 (the new CORESET #0) for RedCap UEs are configured in MIB, SIB1, and/or SIBx. Different combinations of embodiments of configuring the new initial DL BWP and the enhanced CORESET #0 including the new CORESET #0 are shown in Table 9 and FIG. 20.

The new initial DL BWP is associated with new CORESET #0. The new DL BWP contains the entire new CORESET #0. The configuration of new CORESET #0 is similar to the aforementioned embodiments.

Optionally, the gNB 20 may transmit to UEs an indication in MIB/SIB1/SIBx that indicates whether to enable or disable the new initial DL BWP and/or the new CORESET #0. If the new resources of the new initial DL BWP and/or the new CORESET #0 is disabled, all UEs including RedCap UEs may operate on the corresponding legacy resources. If the new resources of the new initial DL BWP and/or the new CORESET #0 is enabled, the RedCap UEs may operate on the corresponding new resources. The indication can be disable/enable later via MIB, SIB, SIBx, or RRC after the gNB 20 identifies the UE type. Table 13 shows examples of configuring the indication.

TABLE 13

| | Disable/Enable indication: | | | |
|---|---|---|---|---|
| New CORESET#0 | Disable | Enable | Enable | Disable |
| New initial DL BWP | Disable | Enable | Disable | Enable |

For msg2, msg4, and/or msgB, if the gNB 20 recognizes the RedCap UE type of one or more RedCap UEs by early identification based on a separate initial UL BWP, a separate preamble, or a separate Rach occasion of the UE, the gNB 20 transmits the DL messages msg2, msg4, and/or msgB at least in new CORESET #0 or new initial DL BWP. If the gNB 20 does not recognize RedCap UE type, the gNB 20 transmit the DL messages msg2, msg4, and/or msgB in both legacy CORESET #0 and new CORESET #0 (the new initial DL BWP). The RedCap UEs receive the DL message in new CORESET #0 (new initial DL BWP). The procedures are described in the following.

After the configuration/enablement of new initial DL BWP and new CORESET #0, DL message (e.g., SIBx, msg2, msg4, msgB, etc.) can be operated in new initial DL BWP or new CORESET #0 (i.e., the gNB 20 can transmit the DL messages to the RedCap UEs in the new initial DL BWP).

Optionally, messages are operated still in the new CORESET #0 before and during random access. That is, the new initial DL BWP may not be used immediately after being configured or enabled. In other word, when the new initial DL BWP cannot be used immediately after being configured, the RedCap UEs may initially receive one or more DL messages in the legacy CORESET #0, and subsequently, receive one or more DL messages in new CORESET #0 from the gNB 20.

Optionally, a part of the DL messages is operated in the legacy CORESET #0, and a part of the DL messages is operated in the new CORESET #0, and a part of the DL messages is operated in the new initial DL BWP. For example, when the enhanced common CORESET for the extended UE type is enabled, a first downlink message is transmitted in the common CORESET for the legacy UE type from the gNB 20 to the UE 10, a second downlink message is transmitted in the enhanced common CORESET for the extended UE type from the gNB 20 to the UE 10, and a third downlink message is transmitted in the initial downlink bandwidth part for the extended UE type from the gNB 20 to the UE 10. Alternatively, when the enhanced common CORESET for the extended UE type is not enabled, the first downlink message and the second downlink message are transmitted in the common CORESET for the legacy UE type from the gNB 20 to the UE 10, and the third downlink message is transmitted in the initial downlink bandwidth part for the extended UE type from the gNB 20 to the UE 10. The initial downlink bandwidth part for the extended UE type may be enabled by the first downlink message or the second downlink message. The enhanced common CORESET for the extended UE type may be enabled by the first downlink message. The first downlink message may comprise an SSB, the second downlink message may comprise a SIB with an index one (SIB1) or a SIB with a greater index (SIBx), and the third downlink message may comprise a random access downlink message, and the random access downlink message comprises msg2, msg4, or msgB. For example, the gNB 20 transmits to UEs a SSB in the legacy CORESET #0, a SIB1 and a SIBx in new CORESET #0, a msg2, msg4, or msgB in new initial DL BWP.

The following mainly describes the case in which Initial DL BWP is in effect during or before random access.
(1) With reference to FIG. 22, when the new initial DL BWP is configured in SIB1, and the gNB 20 doesn't recognize the type of UE in transmitting non-on-demand SIBx, the gNB 20 transmits the non-on-demand SIBx at least in the legacy CORESET #0.
   If the new initial DL BWP is enabled, the gNB 20 can transmit SIBx in the new CORESET #0 and in the legacy CORESET #0 at the same time. The RedCap UEs receive SIBx in the legacy CORESET #0 or the new CORESET #0.
   If the new initial DL BWP is enabled, the gNB 20 can transmit SIBx in the new initial DL BWP and in the legacy CORESET #0 at the same time. The RedCap UEs receive the SIBx in the legacy CORESET #0 or the new initial DL BWP.
   If the new initial DL BWP is disabled, the SIBx is operated in the legacy CORESET #0, i.e., the gNB 20 can transmit SIBx in the legacy CORESET #0, and the RedCap UEs receive SIBx in the legacy CORESET #0.
(2) For on-demand SIBx, if the gNB 20 recognizes the RedCap UE type of one or more RedCap UEs from the information that carrying system information request, the gNB 20 transmits on-demand SIBx at least on either new CORESET #0 or the new initial DL BWP:
   Note that the embodiment does not preclude that the gNB 20 transmits on-demand SIBx both in the new initial DL BWP and the legacy CORESET #0. The RedCap UEs receive the on-demand SIBx in the new CORESET #0, the new initial DL BWP, or the legacy CORESET #0 in which the on-demand SIBx is transmitted by the gNB 20.
   Note that the embodiment does not preclude that the gNB 20 transmits SIBx only in the legacy CORESET #0, and the RedCap UEs receive SIBx in the legacy CORESET #0.
   If the gNB 20 does not recognizes the RedCap UE type of one or more RedCap UEs from the information that carrying a system information request, the gNB 20 transmits on-demand SIBx at least in the legacy CORESET #0:
   The gNB 20 can transmit on-demand SIBx in the new initial DL BWP and the legacy CORESET #0 at the same time. The RedCap UEs receive the on-demand SIBx in the legacy CORESET #0 or new initial DL BWP.
   The gNB 20 can transmit on-demand SIBx in new CORESET #0 and the legacy CORESET #0 at the same time. The RedCap UEs receive the on-demand SIBx in the legacy CORESET #0 or new CORESET #0 (if there is a transmission).
(3) FIG. 26 shows examples of a random access (RA) procedure. For msg2, msg4, and/or msgB, if the gNB 20 recognizes the RedCap UE type by early identification based on a separate initial UL BWP, a separate preamble, or a separate Rach occasion of the UE, the gNB 20 transmits the DL messages msg2, msg4, and/or msgB at least on either new initial DL BWP or new CORESET #0. Note that the embodiment does not preclude that the gNB 20 transmits the DL messages msg2, msg4, and/or msgB in both new CORESET #0 and legacy CORESET #0 or only in the legacy CORESET #0.
   If the gNB 20 does not recognize RedCap UE type, the gNB 20 transmits the DL messages msg2, msg4, and/or msgB at least in the legacy CORESET #0. Note that the embodiment does not preclude that the gNB 20 transmits the DL messages msg2, msg4, and/or msgB in both new CORESET #0 (new initial DL BWP) and legacy CORESET #0.
(4) For SSB and paging, the gNB 20 transmits the messages SSB and paging messages in the legacy CORESET #0 or new initial DL BWP or new initial CORESET #0.

### CORESET #0 Extension for RedCap UEs:

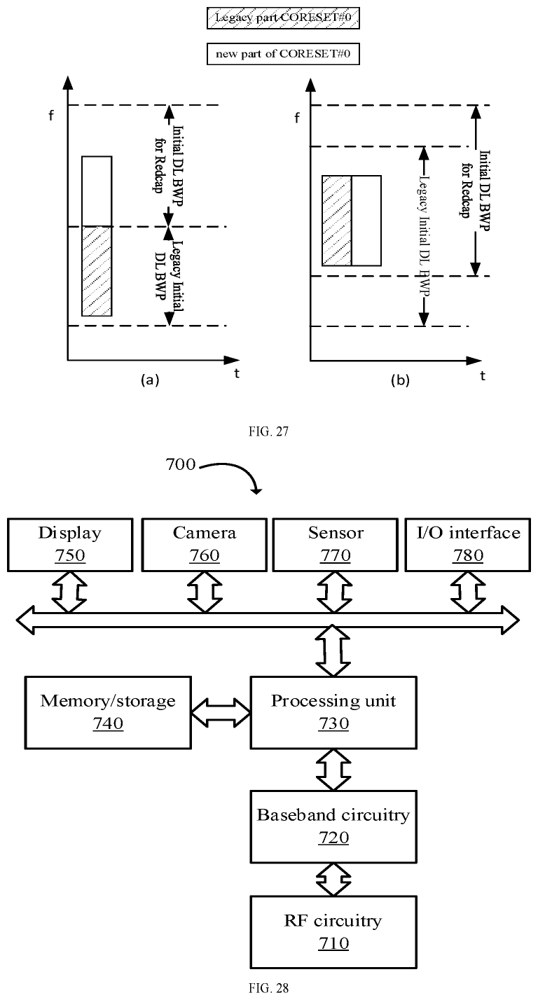

In this embodiment, the RedCap UEs have a separate initial DL BWP and an additional part (e.g., part 51 in FIG. 27) of the legacy CORESET #0 (e.g., CORESET #0 401 in FIG. 27) for the RedCap UEs. The additional part (e.g., part 51 in FIG. 27) is extended radio resources of the legacy CORESET #0, and as a consequence, the additional part (e.g., part 51 in FIG. 27) and the legacy part (e.g., part 41 in FIG. 27) share the same index. The additional part (e.g., part 51 in FIG. 27) can be FDMed or TDMed with the legacy part (e.g., part 41 in FIG. 27). The separate initial DL BWP and the additional part may be configured in MIB or SIB1 or SIBx.

The whole process is similar to the separate CORESET #0 for the RedCap UEs as described in the aforementioned embodiments, except for the configuration of the additional part of the legacy CORESET #0 for the RedCap UEs is similar to the aforementioned embodiments.

The configuration and enablement mode of additional part of the legacy CORESET #0 for RedCap UEs are similar to the aforementioned embodiments described for the CORESET #0 extension.

The configuration and enablement mode of the new initial DL BWP are similar to the aforementioned embodiments.

The procedure of message transmission is similar to the aforementioned embodiments.

FIG. 28 is a block diagram of an example system 700 for wireless communication according to an embodiment of the present disclosure. Embodiments described herein may be implemented into the system using any suitably configured hardware and/or software. FIG. 28 illustrates the system 700 including a radio frequency (RF) circuitry 710, a baseband circuitry 720, a processing unit 730, a memory/storage 740, a display 750, a camera 760, a sensor 770, and an input/output (I/O) interface 780, coupled with each other as illustrated.

The processing unit 730 may include circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

In various embodiments, the system 700 may be a mobile computing device such as, but not limited to, a laptop computing device, a tablet computing device, a netbook, an ultrabook, a smartphone, etc. In various embodiments, the system may have more or less components, and/or different architectures. Where appropriate, the methods described herein may be implemented as a computer program. The computer program may be stored on a storage medium, such as a non-transitory storage medium.

The embodiment of the present disclosure is a combination of techniques/processes that can be adopted in 3GPP specification to create an end product.

If the software function unit is realized and used and sold as a product, it can be stored in a readable storage medium in a computer. Based on this understanding, the technical plan proposed by the present disclosure can be essentially or partially realized as the form of a software product. Or one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

An embodiment of the invention provides an initial access method to address the problems of heavy traffic offloading of initial DL BWP. An embodiment of the invention provides an initial access method to address the problems of the same center frequency issue of initial DL/UP BWP in TDD case.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. An initial access method for an extended user equipment (UE) type, executable in a base station (BS), comprising:
broadcasting configuration of a common control-resource set (CORESET) for RedCap UE; and
broadcasting configuration of an initial downlink bandwidth part (BWP) for the RedCap UE in the common control-resource set;
wherein the configuration of the initial downlink BWP is carried in a system information block SIB); and
the initial downlink BWP is a separated initial downlink BWP dedicated to the RedCap UE or an initial downlink BWP shared by different UE types at least including the RedCap UE.

2. The method of claim 1, wherein a bandwidth of the initial downlink bandwidth part for the RedCap UE is less than or equal to the maximum bandwidth of the RedCap UE.

3. (canceled)

4. The method of claim 1, wherein the initial downlink bandwidth part for the RedCap UE is operable to be enabled or disabled.

5. The method of claim 4, wherein an indication for enabling or disabling the initial downlink bandwidth part for the RedCap UE is transmitted in a master information block (MIB), a system information block (SIB) with an index one (SIB1), a SIB with a different index (SIBx), or a radio resource control (RRC) message.

6. The method of claim 4, wherein when the initial downlink bandwidth part for the RedCap UE is enabled, one or more downlink messages for the RedCap UE is transmitted in the initial downlink bandwidth part for the RedCap UE; and
when the initial downlink bandwidth part for the RedCap UE is not enabled, one or more downlink messages for the RedCap UE is transmitted in the common CORESET for the legacy UE type.

7. The method of claim 6, wherein when an enhanced common CORESET for the RedCap UE is enabled, a first downlink message is transmitted in the common CORESET for the legacy UE type, a second downlink message is transmitted in the enhanced common CORESET for the RedCap UE, and a third downlink message is transmitted in the initial downlink bandwidth part for the RedCap UE; or
when the enhanced common CORESET for the RedCap UE is not enabled, the first downlink message and the second downlink message are transmitted in the common CORESET for the legacy UE type, and the third downlink message is transmitted in the initial downlink bandwidth part for the RedCap UE.

8-12. (canceled)

13. The method of claim 1, wherein the base station recognizes the RedCap UE based on at least one of a separate initial uplink BWP, a separate random access channel (RACH) preamble, msg3, msgA, or a separate RACH occasion of the RedCap UE.

14-15. (canceled)

16. The method of claim 1, wherein the separated initial downlink BWP dedicated to the RedCap UE comprises an entirety of a common CORESET shared by different UE types that at least comprise the RedCap UE.

17. The method of claim 16, if the configuration of the initial downlink bandwidth part, BWP, for the Redcap UE is absent, the entire common CORESET shared by the different UE types is used as the initial DL BWP for the RedCap UE before and during random access processing.

18-29. (canceled)

30. A base station comprising:
a processor, configured to call and run a computer program stored in a memory, to cause a device in which the chip is installed to execute the method of claim 1.

31-34. (canceled)

35. An initial access method for an extended user equipment (UE) type, executable in a user equipment (UE), comprising:
receiving broadcast configuration of a common control-resource set (CORESET) for the RedCap UE; and
receiving broadcast configuration of an initial downlink bandwidth part (BWP) for the RedCap UE in the common control-resource set;
wherein the configuration of the initial downlink BWP is carried in a system information block, SIB; and
the initial downlink BWP is a separated initial downlink BWP dedicated to the RedCap UE or an initial downlink BWP shared by different UE types at least including the RedCap UE.

36. The method of claim 35, wherein a bandwidth of the initial downlink bandwidth part for the RedCap UE is less than or equal to the maximum bandwidth of the RedCap UE.

37. The method of claim 35, wherein the initial downlink bandwidth part for the RedCap UE is a separated initial downlink bandwidth part dedicated to the RedCap UE in addition to an initial downlink bandwidth part for a legacy UE type.

38. (canceled)

39. The method of claim 38, wherein the initial downlink bandwidth part for the RedCap UE is operable to be enabled or disabled;
an indication for enabling or disabling the initial downlink bandwidth part for the RedCap UE is received in a MIB, a SIB1, a SIBx, or an RRC message.

40. The method of claim 38, wherein when the initial downlink bandwidth part for the RedCap UE is enabled, one or more downlink messages for the RedCap UE is received in the initial downlink bandwidth part for the RedCap UE; and
when the initial downlink bandwidth part for the RedCap UE is not enabled, one or more downlink messages for the RedCap UE is received in the common CORESET for the legacy UE type.

41. The method of claim 40, wherein when an enhanced common CORESET for the RedCap UE is enabled, a first downlink message is received in the common CORESET for the legacy UE type, a second downlink message is received in the enhanced common CORESET for the RedCap UE, and a third downlink message is received in the initial downlink bandwidth part for the RedCap UE; or
when the enhanced common CORESET for the RedCap UE is not enabled, the first downlink message and the second downlink message are received in the common CORESET for the legacy UE type, and the third downlink message is received in the initial downlink bandwidth part for the RedCap UE.

42-45. (canceled)

46. The method of claim 40, wherein at least one of a separate initial uplink BWP, a separate random access channel (RACH) preamble, msg3, msgA, or a separate RACH occasion of the RedCap UE is used for recognition of the RedCap UE.

47-48. (canceled)

49. The method of claim 35, wherein the separated initial downlink BWP dedicated to the RedCap UE comprises an entirety of a common CORESET shared by different UE types that at least comprise the RedCap UE.

50. The method of claim 49, wherein if the configuration of the initial downlink bandwidth part, BWP, for the Redcap UE is absent, the entire common CORESET shared by the different UE types is used as the initial DL BWP for the RedCap UE before and during random access processing.

51-61. (canceled)

62. A user equipment (UE) comprising:
a processor, configured to call and run a computer program stored in a memory, to cause a device in which the chip is installed to execute the method of claim 35.

63-95. (canceled)
